(19) United States
(12) Patent Application Publication
(10) Pub. No.: US 2020/0193469 A1
(43) Pub. Date: Jun. 18, 2020

(54) SYSTEM AND METHOD FOR UPDATING A STORED RECORD ASSOCIATED WITH A SUBSCRIBER OF A PROGRAM

(71) Applicant: Phrenzi Limited, Central (HK)

(72) Inventors: John Matthew MCGUIRE, Central (HK); David Christian STROHM, Central (HK); Ryan Michael Ashby SPEARS, Central (HK)

(73) Assignee: Phrenzi Limited, Central (HK)

(21) Appl. No.: 16/607,843

(22) PCT Filed: Apr. 24, 2018
(86) PCT No.: PCT/IB2018/052824

§ 371 Date: Oct. 24, 2019

(30) Foreign Application Priority Data
Apr. 25, 2017 (HK) 17104215.2

(51) Int. Cl. G06Q 30/02; G06F 16/23

(52) U.S. Cl. CPC G06Q 30/0226; G06F 16/23

(57) ABSTRACT

A computer implemented method of updating a stored record associated with a subscriber of a program. The method includes receiving at a server parameters of a challenge sent from an input device, including a reward associated with the challenge stored in memory of the server. Transmitting details of the challenge to a communication device, via a network interface, enables access by a subscriber. A verification signal is received at the server from a verification device verifying completion or part completion of a challenge by said subscriber, for updating the record associated with the subscriber to include the reward. The challenge may be an overall challenge or a sub-challenge of an overall challenge and the reward may be virtual points, a prize, credit, access to exclusive opportunities, or a combination thereof.

### FIELD OF THE INVENTION

The present invention relates to a system and method for updating a stored record associated with a subscriber of a program.

### BACKGROUND OF THE INVENTION

Many service providers or establishments such as retailers, banks, and airlines offer some form of program which aims to reward patrons for their custom and incentivise patrons to continue to purchase their goods and use their services. There are many examples of such programs which may differ in application but which usually all have the goal of incentivising repeat, increased, or new custom.

One such program may be based on the principle of offering cashback or some other form of reward as a percentage of the amount spent by a patron. For example, many credit card companies incentivise their patrons to use their cards by offering a monetary amount, frequent flyer miles, or some other form of virtual points as a percentage of spend, typically between 0.5 and 3%.

Another such program encourages patrons to continue to purchase the program provider's goods or services. Usually, such a program is based on the principle of offering virtual points, tokens, or access to certain discounts or vouchers in return for being a member of the loyalty program and/or purchasing goods or services. For example, a supermarket retailer program may offer patrons virtual points in return for purchasing products. The number of points rewarded may be determined by a spend-to-point exchange rate such as 1 point per US$1 spent. These virtual points may then be converted into cash vouchers for the purchase of goods from the retailer, promotional items, or even frequent flyer miles. Alternatively or additionally, retailers may offer vouchers for the purchase of goods, access to discounts on particular types or brands of goods and other special offers simply by being a member of the loyalty program.

Other programs may offer tokens or stamps for purchasing goods or services which may ultimately be redeemed for goods or services upon obtaining a requisite number of tokens or stamps. For example, coffee shops or take-out establishments frequently offer programs in which a card or stamp book is provided to enable patrons to obtain stamps, stickers, or tokens for each purchase. When a patron has achieved the requisite number of stamps or other nominal token, the patron is entitled to claim a free item such as a coffee or a collectible item.

Airlines also offer programs to incentivise their patrons to continue to use their services. Such programs are often ‘tiered’ whereby different patrons fall into different tiers depending on the frequency with which they use the airline's services and the amount they spend. In such programs, patrons are typically rewarded with virtual points or ‘miles’ for using the airline's services which can be redeemed for goods or services including free or reduced cost flights, flight upgrades, companion fares, travel related products, and hotel rewards. Patrons that frequently use the airline's services and thereby spend relatively large amounts of money accumulate large numbers of points or miles and fall into upper tiers which provide access to enhanced services such as the use of airport lounges, early boarding, preferential upgrades, and other benefits.

Relatively recent advances in information technology have enabled establishments to offer increasingly sophisticated and complex incentivisation programs. However, such programs typically replicate the standard-model in a digital format and do not fully utilise the opportunities afforded by computer science.

A problem with traditional programs aimed at incentivising increased and/or repeat custom is that they are unable to fully engage all patrons and exploit the opportunities provided by modern technology. Traditional programs are focused on rewarding an individual patron's spending efforts which inherently limits the prizes or benefits obtainable by low spending patrons and in so doing, alienates those low spending patrons and discourages them from active participation in such programs.

Therefore, existing loyalty programs that only measure one dynamic, such as total spend, are relatively inflexible in that they do not enable establishments to define what loyalty means to them and reward patrons accordingly. Patrons can be loyal to an establishment for a number of different reasons and not just because of the size of spend with an establishment. While a loyal patron for one establishment may be an individual that frequently buys the establishment's goods or services, a loyal patron for a different establishment may be a low spend individual that recommends the establishment to friends and acquaintances, thereby generating additional custom that may outweigh the spend of an individual high spending patron. A loyalty program that measures total spend has no way of identifying who that referring patron or “affiliate” is and of rewarding that patron accordingly.

In view of the above, there is need for a more competent loyalty program that empowers establishments to encourage their patrons to market and grow the establishment's business. Consequently, there is a need for a program that offers greater flexibility for establishments to define what loyalty means to them and to identify patrons that might be loyal for reasons other than high spend. There is also a need for a more socially engaging program that enables establishments to more intimately connect with their patrons and incentivise them to generate additional business for establishments through increased individual spend and frequency of spend and also through inciting existing patrons to actively promote an establishment's products and services.

It is an object of the present invention to provide an improved program and method of rewarding patrons of an establishment.

### SUMMARY OF THE INVENTION

In accordance with a first aspect of the present invention, there is provided a computer implemented method of updating a stored record associated with a subscriber of a program comprising:

receiving, by one or more computing devices, one or more parameters of a sub-challenge of an overall challenge sent from an input device, one or more computing devices comprising a memory, a processor, and a network interface;
the one or more parameters including a reward associated with the sub-challenge;
storing the one or more parameters in memory of one or more computing devices;
transmitting, via a network interface, details of the sub-challenge to a communication device accessible by the subscriber of the program;
receiving, by one or more computing devices, a verification signal from a verification device indicating completion of the sub-challenge by the subscriber; and
updating the record associated with the subscriber to include the reward.

Advantageously, a method according to the first embodiment enables an establishment to offer rewards to subscribers of their program that more accurately reflect what it means to be a loyal customer to the establishment. By enabling establishments to define the parameters of a sub-challenge and to offer a reward accordingly, establishments can tailor a loyalty program to match the personality traits and demographics of their customers and at the same time incentivise those customers to generate new business for the establishments by increasing customer spend and encouraging customers to promote the goods and services of the establishment. Therefore, the flexibility to define parameters of challenges and choose customer rewards enables establishments to incentivise customers to generate new business without that necessarily being an increased spend by the customers. Providing sub-challenges to customers also enables establishments to introduce an element of competition into a loyalty program to further incentivise customers to actively participate in a loyalty program to win a reward.

The verification signal may comprise data facilitating identification of the subscriber and data facilitating determination that criteria for completion of the sub-challenge have been met.

The method may further comprise determining, by one or more computing devices, completion of a sub-challenge based upon the verification signal.

The method may further comprise selecting a subscriber from a list of subscribers displayed on the verification device or inputting details relating to a subscriber into the verification device, and including in the verification signal data identifying the selected subscriber.

The sub-challenge may include one or more of purchasing goods or services, visiting a physical location, inviting others to visit a physical location, inviting an individual to complete a task, purchasing specific goods or services, purchasing a minimum value or minimum number of goods or services, viewing video content, promoting an establishment through social media channels, providing feedback to an establishment, completing a knowledge based game, or completing a task.

The one or more parameters may further include one or more of a time constraint, quantity constraint, reward multiplier, set number of points, start time, end time, start date, restriction on the number of times a sub-challenge may be completed by the subscriber, or restriction on the total number of rewards that may be awarded to the subscriber for a given sub-challenge. At least one parameter may be selected from one or more pre-configured parameter types.

The reward may comprise a number of virtual points, a prize, cashback, credit, access to one or more exclusive opportunities, or a combination thereof. Optionally, prize information may be displayed at any one or more of the beginning of the sub-challenge/challenge, during the sub-challenge/challenge and after the completion of the challenge/sub-challenge. Prize information displayed during the sub-challenge may be dynamically updated during the challenge.

Communication between a communication device and the server may take place over a network.

The method may further comprise the step of activating an alert on the communication device accessible by the subscriber of the program to cause details of an overall challenge or sub-challenge to display on a display of the communication device accessible by the subscriber of the program to enable the subscriber of the program to participate in the overall challenge or sub-challenge.

The method may further comprise the step of comparing the record of a participating subscriber of an overall challenge with respective records of one or more other participating subscribers, ranking each participating subscriber in order based on the respective records, and transmitting the ranking to one or more communication devices for displaying the ranking on a display of one or more communication devices.

Sending of a verification signal verifying completion or part completion of a sub-challenge may be activated by a software application. Activation by the software application may be triggered by receipt of data by the verification device confirming completion or part completion of a sub-challenge by the subscriber.

The method may further comprise the step of monitoring the location of one or more subscribers.

The method may further comprise the step of displaying details of one or more subscribers on the verification device when one or more subscribers is determined to be at, or within a specified distance of, a specified location.

The method may further comprise the step of updating the record associated with a subscriber to include a reward when the subscriber is determined to be at, or within a specified distance of, the specified location.

In accordance with a second aspect of the present invention, there is provided a computer implemented method of verifying completion of a sub-challenge of an overall challenge by a subscriber of a program, said sub-challenge being associated with a reward for completion of the sub-challenge, the method comprising:
receiving, by one or more computing devices, information relating to the completion of the sub-challenge, said information including data for identification of the subscriber;
sending, by one or more computing devices, an identification request to a verification device, said identification request including said data for identification of the subscriber;
selecting, based on said data for identification of the subscriber, a subscriber from a list of subscribers displayed on the verification device or inputting details associated with a subscriber into the verification device; and
sending, by the verification device, a verification signal to one or more computing devices, said verification signal including details associated with the selected subscriber; and
updating, by one or more computing devices, a stored record associated with the subscriber to include the reward associated with the sub-challenge.

The method may further comprise determining, by one or more computing devices, completion of a sub-challenge based on said information relating to the completion of the sub-challenge and/or said verification signal.

The information relating to the completion of the sub-challenge may comprise data relating to the order of goods and/or services and said data for identification of the subscriber may comprise a unique identifier associated with the order of goods and/or services.

The method may further comprise sending to one or more computing devices the information relating to the completion of the sub-challenge.

In accordance with a third aspect of the present invention, there is provided a computer based system for updating a stored record associated with a subscriber of a program comprising:

one or more computing devices comprising a memory, a processor, and a network interface, one or more computing devices operable to receive one or more parameters of a sub-challenge of an overall challenge sent from an input device and store the one or more parameters in memory, the one or more parameters including a reward associated with the sub-challenge;
one or more computing devices operable, via a network interface, to transmit details of the sub-challenge including at least one parameter of the one or more parameters to a communication device accessible by the subscriber of the program;
wherein one or more computing devices are configured to update the record associated with the subscriber to include the reward upon receipt of a verification signal indicating completion or part completion of a sub-challenge sent from a verification device.

The computer based system may further comprise one or more communication devices accessible by one or more subscribers of a program. The computer based system may further comprise a verification device for transmitting the verification signal indicating completion of a sub-challenge to the server.

The verification device, input device, and/or communication device may be the same device.

### BRIEF DESCRIPTION OF THE DRAWINGS

Preferred embodiments of the present invention will be explained in further detail below by way of examples and with reference to the accompanying drawings, in which:—

FIG. 1 shows a schematic representation of a system implementing a loyalty program according to the present disclosure;

FIG. 2 shows a flow diagram of a method for implementing a challenge and/or sub-challenge for a loyalty program and transmitting details of the challenge and/or sub-challenge to a subscriber of a loyalty program;

FIG. 3 shows a further part of the flow diagram shown in FIG. 2 including updating a stored record of a subscriber participating in the challenge and/or sub-challenge;

FIG. 4 shows a flow diagram of a method of updating a challenge or sub-challenge with amended parameters;

FIG. 5 shows a schematic of the system shown in FIG. 1 and a first event of a possible sequence of events in the implementation of a loyalty program;

FIG. 6 shows a second event of a possible sequence of events in the implementation of the loyalty program;

FIG. 7 shows a third event of a possible sequence of events in the implementation of the loyalty program;

FIG. 8 shows a flow diagram depicting the creation of a check-in sub-challenge;

FIG. 9 shows a schematic representation of the system detecting a communication device in close proximity to a location and displaying details of an individual known by the system to be associated with the detected communication device;

FIG. 10 shows a flow diagram depicting the creation of an invitation sub-challenge;

FIG. 11 shows a flow diagram depicting the creation of a target amount sub-challenge;

FIG. 12 shows a flow diagram depicting the creation of a purchase sub-challenge;

FIG. 13 shows a flow diagram depicting the creation of a social sub-challenge;

FIG. 14 shows a flow diagram depicting the creation of a video sub-challenge;

FIG. 15 shows a flow diagram depicting the creation of a feedback sub-challenge;

FIG. 16A shows a flow diagram depicting the creation of a task sub-challenge;

FIG. 16B shows a flow diagram depicting the creation of a credit sub-challenge;

FIG. 16C shows a flow diagram depicting the creation of a knowledge sub-challenge;

FIG. 17 shows a schematic representation of the system shown in FIG. 1 interfacing with a point of sale system of an establishment;

FIG. 18 shows a graphical representation of a baseline prize award model;

FIG. 19 shows a graphical representation of a winner differential based prize award model;

FIG. 20 shows a chart comparing the prizes awarded with a winner differential model with the prizes awarded with a baseline model for a given number of winners;

FIG. 21 shows a chart showing the effect of changing the winner differential on the awarded prizes;

FIG. 22 shows a chart of prize amount per winner against number of winners for a given winner differential;

FIG. 23 shows a chart of the percentage of winners earning more than the baseline against winner differential for different numbers of winners;

FIG. 24 shows a chart of prize amount per winner according to a winner differential prize distribution model, separated into three tiers;

FIG. 25 shows a chart of prize amount per winner according to a linear prize distribution model, separated into three tiers;

FIG. 26 shows a schematic representation of pages of a user interface of an establishment account of the system; and

FIG. 27 shows a schematic representation of pages of a user interface of a subscriber account of the system.

### DETAILED DESCRIPTION OF THE PREFERRED EMBODIMENTS

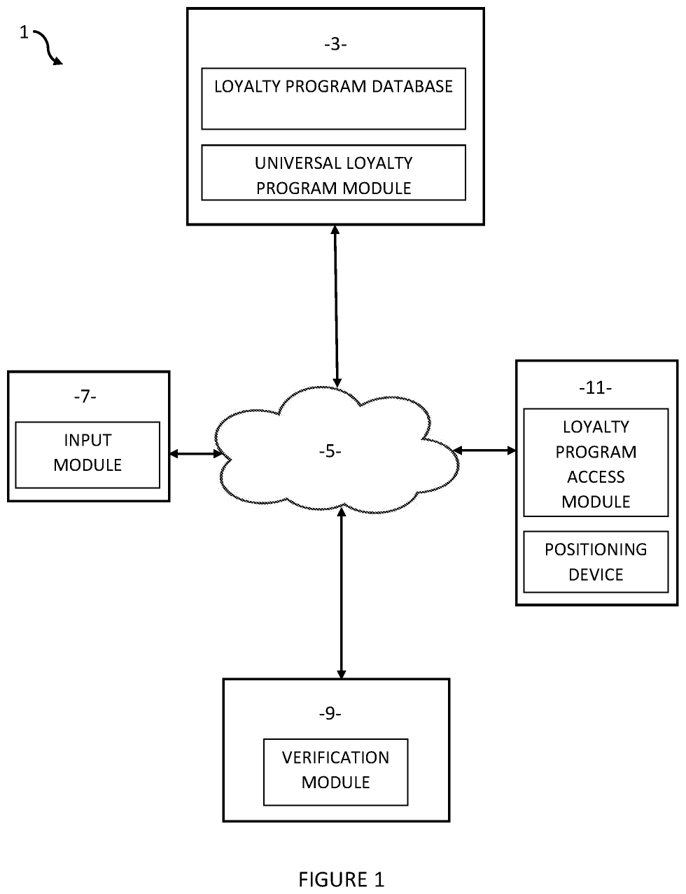

Referring to FIG. 1, there is shown a computer implemented system 1 for updating a stored record associated with a subscriber of a program, such as a loyalty program of an establishment selling goods and/or services. For example, the system 1 can be used by an establishment to define the parameters of an overall challenge that incentivises patrons who subscribe to an establishment's loyalty program to generate business for the establishment by awarding virtual points for completing actions throughout the overall challenge. Subscribers may be incentivised to complete as many actions as possible in return for virtual points by awarding a prize to subscribers with the greatest numbers of virtual points at the end of the overall challenge. In addition to the award of virtual points, establishments may configure a loyalty program to offer traditional cashback or store credit for purchased goods and/or services as a percentage of the purchase price. Thus, subscribers of an establishment's program can earn cashback or store credit even if they do not take part in an establishment's overall challenge or even if an establishment has not configured an overall challenge to run over a particular period.

The system 1 comprises a program server 3 for communication with other electronic devices across a network 5, one or more input devices 7 for input of challenge parameter data and transmission of the challenge parameter data to the program server 3 via the network 5, one or more verification devices 9, and one or more communication devices 11 accessible by subscribers of the loyalty program for communication between the program server 3 and the subscribers via the network 5. It will be appreciated by a person skilled in the art that a verification device 9, input device 7, and communication device 11 could be the same device. For example, a computing device may be used as an input device 7 for the input of challenge and sub-challenge parameters for transmission to the program server 3, as well as management of the loyalty program, and the same computing device may be used as the verification device 9 for identification of participating subscribers of the overall challenge and verification of completion or part completion of one or more sub-challenges of the overall challenge.

The network 5 can be any type of communications network, such as a wide area network (e.g. the Internet). Communication between the server 3, one or more input devices 7, one or more verification devices 9, and one or more communication devices 11 can be achieved via a network interface using any type of wired or wireless connection, using a variety of communication protocols (e.g. HTTP, HTTPS, TCP/IP) and over which encoded human/machine readable information is transmitted (e.g. HTML, JSON (JavaScript Object Notation). The network 3 can connect the program server 3 with any number of input devices 7, verification devices 9, or communication devices 11.

The program server 3 is at least one computing device comprising a processor for performing operations and a memory for storing instructions for the processor to perform desired operations. The program server 3 further includes a network interface for communication and transmission of data between the input devices 7, verification devices 9, and communication devices 11 across the network 5. The program server 3 includes or is in communication with a loyalty program database storing program data used in the loyalty program to be served to the input devices 7, verification devices 9, and one or more communication devices 11. The program server 3 hosts a universal loyalty program module that controls aspects of the loyalty program, receives and transmits data relating to the loyalty program between the input devices 7, verification devices 9, and the communication devices 11 and updates recorded data based on received data from the input devices 7, verification devices 9, and communication devices 11.

It will be appreciated by persons skilled in the art that the term “module” refers to computer logic utilized to provide desired functionality of a computing device and other electronic devices and peripherals. Thus, a module can be implemented in hardware, firmware, and/or software controlling a general purpose processor. In one embodiment, the modules are program code files stored on the communication device or server, loaded into memory, and executed by a processor or can be provided from computer program products, for example computer executable instructions, that are stored in a tangible computer-readable storage medium such as RAM hard disk, or optical or magnetic media.

The program server 3 is configured to receive loyalty program data from the input devices 7, verification devices 9, and communication devices 11, respectively. The universal loyalty program module is operable to update the loyalty program database accordingly based on received program data. Program data may include parameters for an overall challenge or sub-challenge set by an establishment, details of subscribers including the subscriber's name and photograph, a subscriber's stored record such as total accumulated virtual points and store credit, subscriber location, verification signals confirming completion of a task or action that is associated with a virtual points award, purchase information, prizes awarded to a subscriber during an overall challenge, prize fund for an overall challenge, and ranking of subscribers in an overall challenge. The program server 3 may additionally comprise data provided by an operator of the computer implemented system 1 including data related to fees charged to establishments for using the computer implemented system 1, rankings of top performing establishments in terms of fees generated for the system operator in a given month, and rewards offered to top performing establishments to incentivise establishments to generate more business via the computer implemented system 1.

An input device 7 is a computing device comprising a processor for performing operations, a memory for storing instructions for the processor to perform desired operations, and a network interface for communication with electronic devices across the network 5. The input device 7 can be any computing device that can be used to communicate with the program server 3 and permit the input of data including parameters relating to a proposed activity for transmission to the program server 3 over the network 5. The input device 7 could additionally or alternatively include an input module which operates as a program input application providing an establishment with an interface to the system 1 so that the establishment can amend or create an overall challenge or sub-challenge even while mobile. Suitable input devices 7 include smartphones, personal computers, tablet computers, or any other device capable of communicating over the network 5 and enabling interaction with a user for the input of data and communication of data across the network 5.

A verification device 9 can be any computing device that can be used to communicate with the program server 3 and transmit data to the program server 3 over the network 5. For example, the verification device 9 can be a wireless device, a personal digital assistant (PDA), smartphone, personal computer, tablet, point of sale terminal, or other such device. The verification device 9 comprises a processor for performing operations, a memory for storing instructions for the processor to perform desired operations, and input/output devices such as a display screen, touch screen, touch pad, data entry keys, speakers, scanning apparatus, image capture device, and/or a microphone suitable for voice recognition to enable verification information to be optionally entered into the verification device 9 for transmission to the program server 3. The verification device 9 includes a verification module stored on the verification device memory and operable to generate a verification signal comprising data identifying a subscriber for transmission to the program server 3 and to display details received from the program server 3 of one or more subscribers on the verification device 9 display screen. The verification device 9 further comprises a network interface to enable communication between the program server 3 and the verification device 9 over the network 5.

The one or more communication devices 11 can be any computing device that can be used to communicate with the program server 3 over the network 5. For example, one or more additional communication devices 11 can be a wireless device, a personal digital assistant (PDA), portable gaming device, smartphone, personal computer, tablet, or other such device. The communication devices 11 may be any electronic device that can execute a loyalty program module to allow a subscriber of the program to interface with the program server 3. The communication devices 11 comprise a processor for performing operations, a memory for storing instructions for the processor to perform desired operations, and input/output devices such as a display screen, touch screen, touch pad, data entry keys, speakers, and/or a microphone suitable for voice recognition. The communication devices 11 further comprise a network interface to enable communication between the server 3 and the communication devices 11 over the network 5.

A communication device 11 may include a positioning means associated with the communication device 11 operable to determine a subscriber's position/location. The position of the subscriber can be used to determine whether or not the subscriber has completed a particular task whereby the subscriber or one or more acquaintances of the subscriber visits a particular location such as an establishment's physical store. The position of the subscriber can also be used by an establishment to quickly identify which subscribers of their loyalty program are present at the establishment's premises. The positioning means can determine actual or relative position by using a satellite navigation positioning system such as a GPS system, based on IP address, by using a triangulation technique, for example, by determining proximity to Wi-Fi hotspots, or other suitable techniques for determining position. Position of a communication device 11 may additionally or alternatively be determined based on Bluetooth Low Energy (BLE) beacons which are positioned at known locations, e.g. within an establishment, and which are configured to transmit Bluetooth signals that are received by a communication device and used to estimate the distance from and, hence, approximate location in relation to the beacon. Alternatively, position of a communication device 11 may be determined using one or more internet of things (IoT) sensors such as microelectromechanical systems (MEMS) sensors or nanoelectromechanical systems (NEMS) sensors installed in or around an establishment which are capable of detecting and monitoring the location of a communication device 11 in real time without the need for wireless communication (such as NFC, RFID, Wi-Fi, Bluetooth), or by using facial recognition technology.

The communication device 11 may comprise a loyalty program access module in the form of a software application ‘app’ stored on the communication device memory which operates as a program application to provide a subscriber with an interface to the system 1. The loyalty program access module enables a subscriber to access information about establishment loyalty programs registered with the system 1, details of challenges and sub-challenges set by establishments for earning points and/or store credit, details of a subscriber's account including virtual points and store credit earned for a given challenge with an establishment, and details of other subscribers' including virtual points total for a given overall challenge, prizes won or due to be won, and ranking within an overall challenge.

Additionally or alternatively, one or more communication devices 11 may include a web browser for displaying web pages received across the network 5 from the program server 3 or a different server storing and serving web pages relating to the loyalty program. The web pages enable a subscriber to access their account and view similar information to that accessible through the loyalty program access module including the total number of personally accumulated virtual points, their ranking in terms of total number of virtual points relative to other subscribers, amount of cashback or store credit earned with an establishment, and the total size of the available prize for a given overall challenge. The web pages also enable subscribers to view and take part in various sub-challenges set by an establishment in order to earn virtual points.

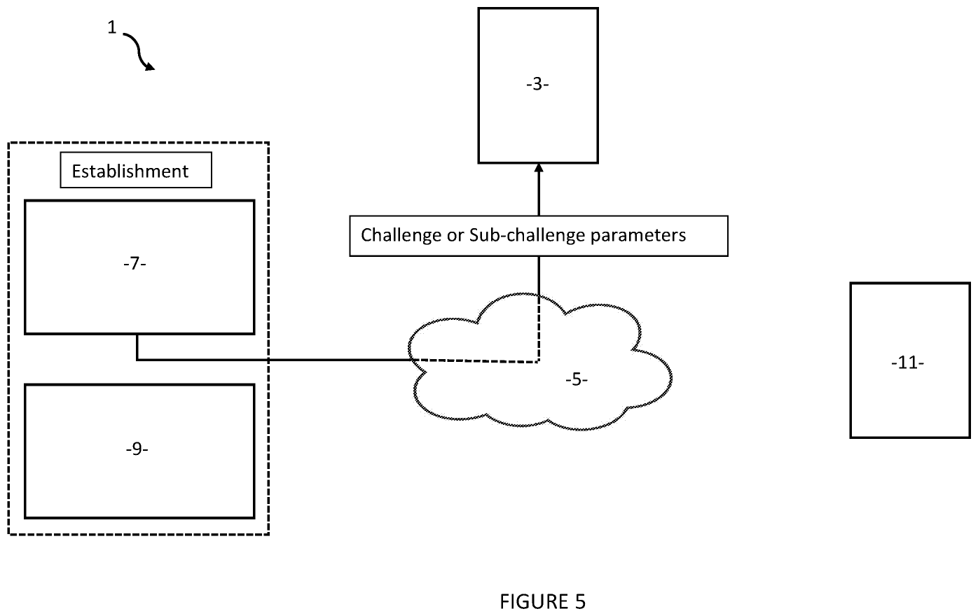

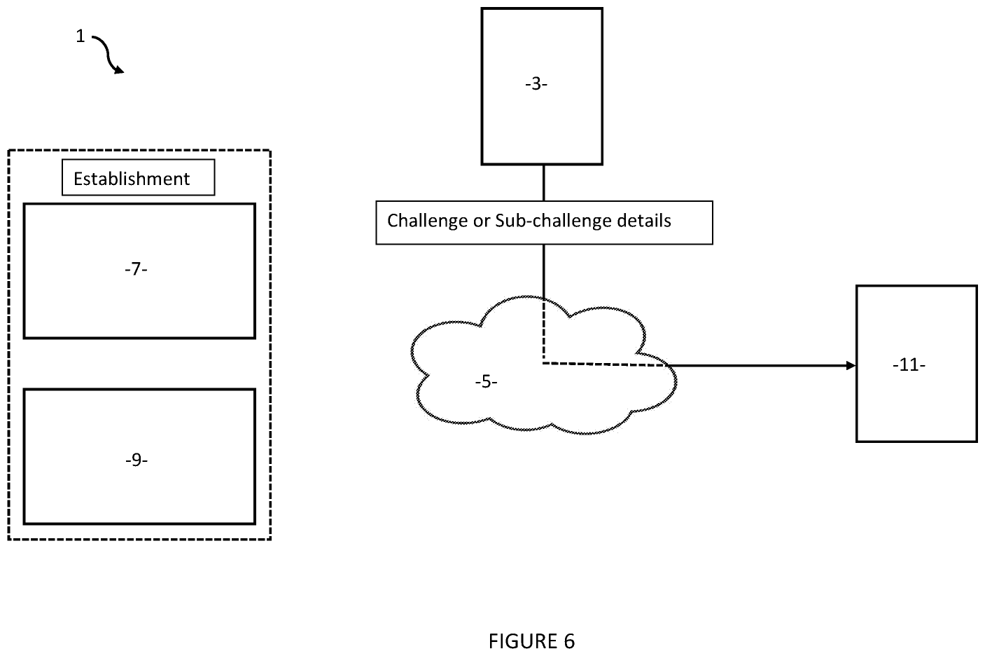

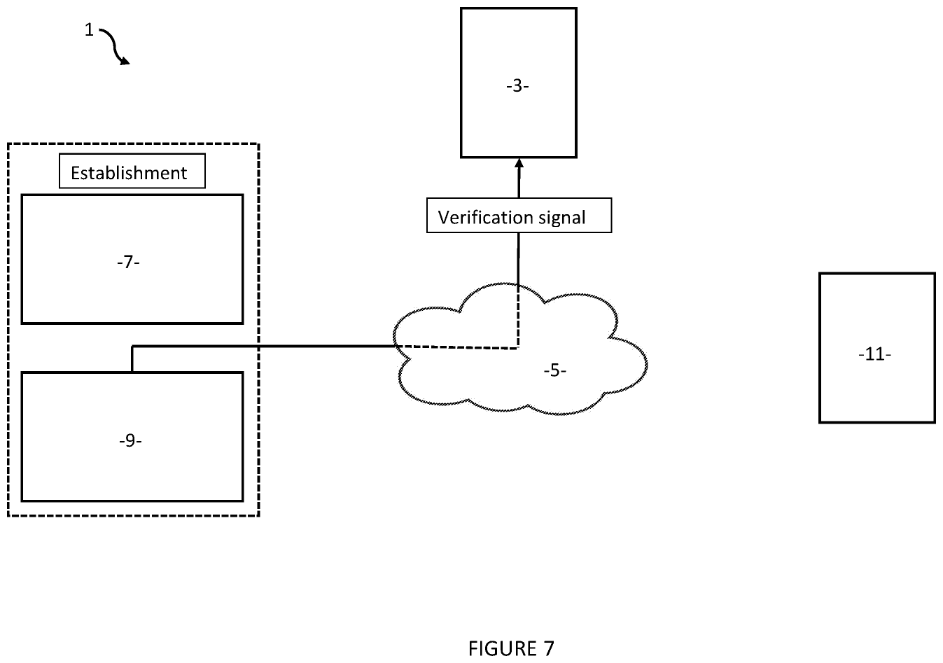

The system 1 facilitates the configuration and implementation of loyalty or incentivisation programs comprising overall challenges which are bespoke to a particular establishment or institution and which include various sub-challenges set by the establishment or institution to encourage participants of the overall challenge to complete certain tasks or undertake certain desired actions. FIGS. 1 to 8, and 10-16 collectively show a schematic of a system 1 and/or sequence of possible events for the creation and maintenance of an overall challenge and/or sub-challenges, and for the participation by one or more subscribers of an establishment's loyalty program. In addition to the overall challenge, establishments may configure the loyalty program to offer cashback or store credit for the purchase of goods/services whether or not a subscriber takes part in the overall challenge and whether or not an overall challenge is active. Thus, every subscriber may benefit from an establishment's loyalty program operated via the system 1 regardless of whether or not a subscriber takes part in an overall challenge. Since a percentage of the sales generated by subscriber purchases may be used to grow the available prize on offer when an overall challenge is active, the cashback or store credit incentive has the added benefit of increasing the attractiveness of the prize on offer and, therefore, of encouraging increased participation of subscribers in an overall challenge.

In the embodiment depicted, the overall challenge can be configured based on three variables, namely, duration (start and end date and time), number of winners (as a percentage of total participants rounded up to the nearest whole number or as a fixed number) and prize, and may be configured to include one or more sub-challenges that actively encourage subscribers to promote the establishment and purchase goods/services. It will be apparent to the person skilled in the art that other parameters may be chosen as desired.

The cashback or store credit aspect of the loyalty program may be configured independently of the overall challenge and set as a percentage of purchase amount. Thus, the cashback or store credit aspect of the loyalty program may be set to run alongside an overall challenge or even when an overall challenge is not active and may be adjusted by an establishment at any time independently of an overall challenge. For example, the level of cashback can be set as a percentage of each purchase such as 1% cashback or 0% where no cashback is to be awarded. The establishment may choose to award cashback or store credit to each patron for the purchase of goods/services whether or not taking part in the overall challenge.

Additionally or alternatively, the system 1 is configured to allow an establishment to offer different levels of store credit in return for the purchase of goods or services as a means of influencing a participating subscriber's spending decisions. For example, the universal loyalty program module of the system 1 is configured to receive from an input device 7 parameters entered by an establishment relating to the offer of store credit as a fixed percentage of spend for all products or services (essentially replicating a traditional cash back model), or as a fixed percentage of spend for a particular type of product or service, or as a fixed percentage of spend for a particular category of products or services. The loyalty program module is further configured to receive parameters via an input device 7 from an establishment relating to the offer of store credit incentives for a time restricted period or a limited quantity, and may optionally allow the establishment to restrict a store credit incentive to a maximum amount for a participating subscriber. The universal loyalty program module is further configured to update the stored record of a participating subscriber to include the store credit for any qualifying spend during an overall challenge regardless of the completion or outcome of the overall challenge.

In the example of a bar, the establishment may configure a store credit incentive by offering, for example, 5% credit on all drinks orders, or 5% credit on Guinness Draught, or 5% credit on an entire menu. A store credit incentive may, for example, be limited to a 60 minute window (akin to a happy hour) or may be limited to a maximum purchase of, for example, ten drinks. Thus, the establishment can adjust the store credit reward and the timings of the store credit reward to influence participating subscriber's spending habits by offering more credit for purchasing certain goods or services than other types or categories of goods or services, optionally at different times of the day.

The duration of the overall challenge may be any length as desired by the establishment but in the embodiment depicted may be configured to run in one day increments with a minimum duration of one day which is set by choosing a start date and an end date. The prize can be store credit for spending on goods and/or services of the establishment set as a percentage of the combined spend of each subscriber taking part in the overall challenge over the duration of the overall challenge, some other reward such as an especially desirable or valuable item, or any combination thereof. The number of winners can be set as one or more top performers in the overall challenge such as the top performer or the top ten performers, or it can be set as a percentage of the total number of subscribers taking part in the overall challenge (e.g. the top 10%). The prize can be weighted according to the position of each subscriber in the overall challenge.

Where the number of winners is set as a percentage of participating subscribers, the system 1 is configured to permit the establishment to cap the number of winners so that the prize on offer is not excessively diluted with each new participating subscriber of an overall challenge. For example, the number of winners may be set to the top 10% of participating subscribers but capped at 20 winners so that, even if there are, for example, 300 participating subscribers, the total number of potential winners is limited to 20 rather than 30 (i.e. 10% of participating subscribers). This allows the establishment to avoid an undesirable scenario in which the number of participating subscribers is high, but the combined spend of all participating subscribers is low, such that a smaller prize fund is distributed across a larger number of winners, thereby diluting the amount that each top participating subscriber can win and reducing the incentive for participation.

It will be apparent to a person skilled in the art that any number of variables and choices could be made for the configuration of the overall challenge as desired by the establishment.

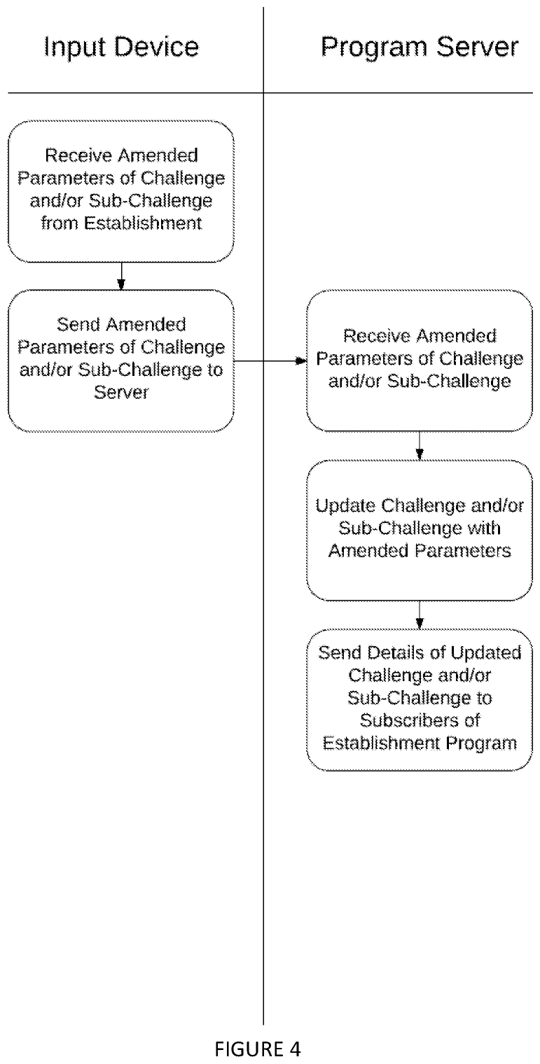

With reference to FIG. 4, the system 1 permits establishments to amend certain modifiable parameters of an overall challenge or sub-challenge before and throughout the duration of the overall challenge and/or sub-challenge. For example, a sub-challenge scheduled to commence on a particular date or at a particular time can be rescheduled to a different date/time. The system 1 also allows establishments to modify the duration and end time of active overall challenges and sub-challenges.

In one example, the loyalty program can be configured to generate an overall challenge that runs for 7 days, that offers a prize of 10% of the combined subscriber spend during the overall challenge to the winners of the overall challenge, that specifies the total number of winners as the top 10% of total subscribers in the overall challenge and that weights the prize fund so that the next winner in the top 10% receives 10% less of the prize than the preceding winner. Optionally, the establishment may also configure the loyalty program to offer cashback of 3% to each subscriber for the purchase of goods and/or services.

The winners of the overall challenge can be determined based on a virtual points scoring system whereby virtual points are awarded to subscribers in return for generally purchasing goods and/or services and completing one or more sub-challenges which may include sub-challenges relating to the purchase of specific products or services, or categories of products or services. For general purchase of goods and/or services, the system 1 is configured to default to a set ratio of one virtual point for every fixed unit of currency spent. For example, the system 1 may be configured to award one virtual point for every $1 USD spent at an establishment. It will be appreciated that this default ratio may be adjusted depending on the currency of the country or region in which an establishment is based. For example, this ratio may be adjusted to one point awarded for every $10 HKD spent in Hong Kong. Whilst the system 1 is configured to default to a fixed ratio as specified by the system operator, it is envisaged that the system 1 may be adjusted to enable the ratio to be changed by an establishment for a particular overall challenge.

The winners of an overall challenge can be determined by ranking the subscriber(s) in order of total points awarded over the duration of the overall challenge. Since the ranking is updated by the universal loyalty program module in real-time, the current leaders may be monitored and tracked by all subscribers throughout an overall challenge to enable a subscriber to determine where they are in the ranking and the required number of virtual points to move up the ranking and achieve a more desirable prize.

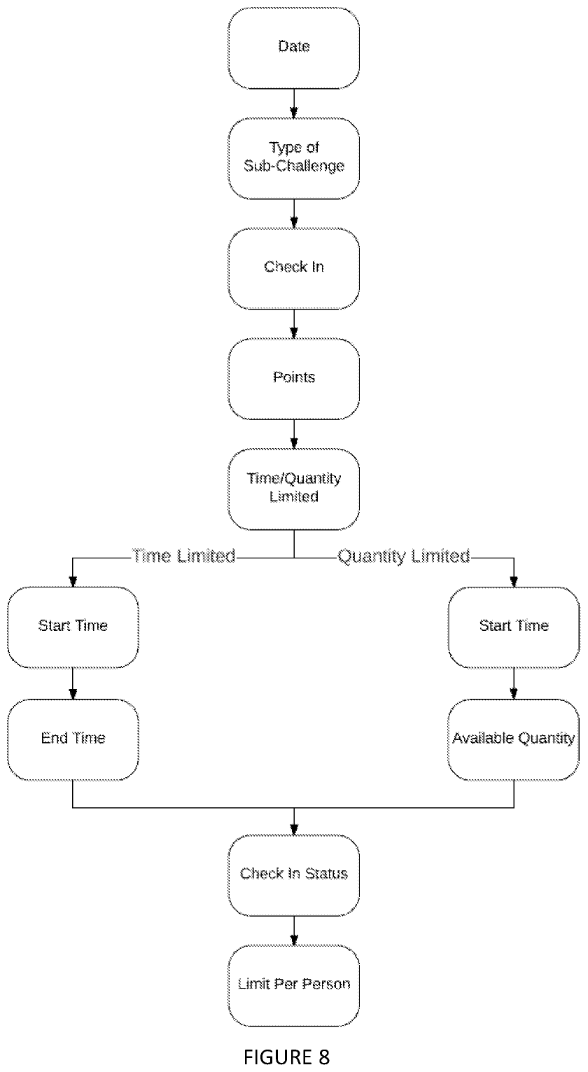

With reference to FIGS. 8, and 10 to 16C, one or more sub-challenges can be included in an overall challenge and configured to increase or ‘boost’ the number of virtual points awarded to subscribers without necessarily linking the sub-challenge to the amount of money generally spent with an establishment. Therefore, subscribers that do not spend significant amounts of money with an establishment can still compete to win the overall challenge by obtaining virtual points for completing sub-challenges. One or more sub-challenges can be configured for inclusion in an overall challenge at the time of creating the overall challenge or during the overall challenge.

In the embodiment depicted, sub-challenges can be configured to run for a limited time within the duration of the overall challenge or they can be quantity limited i.e. limited by the number of times the same sub-challenge may be completed. The sub-challenges can be configured based on a number of parameters. In a first step a start date is chosen for the sub-challenge before a type of sub-challenge is selected. In the described embodiment, the sub-challenge types are limited to pre-configured types, namely, ‘check-in’, ‘invitation’, ‘purchase’, ‘target amount’, ‘social’, ‘video’, ‘feedback’, ‘credit’, ‘knowledge’, and ‘tasks’. It will be apparent to a person of skill in the art that any number of suitable sub-challenge types may be chosen as desired and that this list of sub-types is non-exhaustive.

The configuration of a sub-challenge can be broadly divided into three parts, the first part being the general setup whereby the type of sub-challenge is selected and the amount of virtual points to be awarded specified (or in the case of a credit sub-challenge the amount of store credit to be awarded), the second part being the limiting part at which certain limiting factors are specified such as time or quantity limitations, and the third part being the eligibility part whereby eligibility criteria is specified such as the required status of a subscriber or a limit as to how many times are subscriber may take part in or complete a sub-challenge and be awarded virtual points or store credit (in the case of a credit sub-challenge).

The check-in category type relates to a location based sub-challenge whereby a subscriber is challenged to visit or remain at a location such as an establishment's store. With reference to FIG. 8, the establishment may configure the check-in sub-challenge to award a set number of points for checking-in or remaining at a location, to be time-limited i.e. to run for a particular length of time with a start time and end time (e.g. 15:00-17:00), or to be quantity limited i.e. to restrict the sub-challenge to a particular number of ‘check-ins’ (e.g. the first ten subscribers to check-in), to configure the system to award the virtual points automatically on check-in, and to limit the sub-challenge to one award per subscriber. Advantageously, the check-in sub-challenge can be used to encourage subscribers to visit the establishment during times of the day where business is especially slow for the establishment.

Verification of completion of the check-in sub-challenge may be based on the position of the subscriber as determined by the positioning means of the subscriber's communication device 11, the position of the subscriber's communication device 11 in relation to a wireless communication device located within the establishment (e.g. a wireless access point, Bluetooth Low Energy beacon, Near Field Communication device, or other suitable device), proximity of the subscriber's communication device 11 to one or more sensors such as IoT sensors located in or close to the establishment, and/or as manually confirmed by the establishment. A wireless communication device or sensor may be communicatively linked to a verification device 9 so as to transmit subscriber detection events to the verification device 9 or may, itself, be a part of the verification device 9.

In one example, when the positioning means determines that the subscriber is at the location as set by the sub-challenge, the loyalty program access module of the communication device 11 can transmit a verification signal to the program server 3. In an alternative example, the system 1 may be configured to periodically transmit a position request signal from the program server 3 to each subscriber's communication device 11 to periodically determine location of each subscriber and, hence, their position in relation to an establishment location. In response to a location request, each communication device 11 may transmit a verification signal back to the program server 3 in the form of location data including information enabling identification of the subscriber by the universal loyalty program module.

Additionally, or alternatively, a verification signal including information identifying the subscriber may be generated by a verification device 9 located at the establishment when a communication device 11 is detected by one or more wireless communication devices or one or more IoT sensors at or around the establishment. Upon detection of the subscriber's communication device 11 indicating the subscriber is within the establishment, the verification device 9 may automatically transmit the generated verification signal to the program server 3 where, upon receipt, the universal loyalty program module determines the subscriber has satisfied the criteria of a check-in sub-challenge so that the subscriber's stored record can be updated with the specified reward for the check-in sub-challenge.

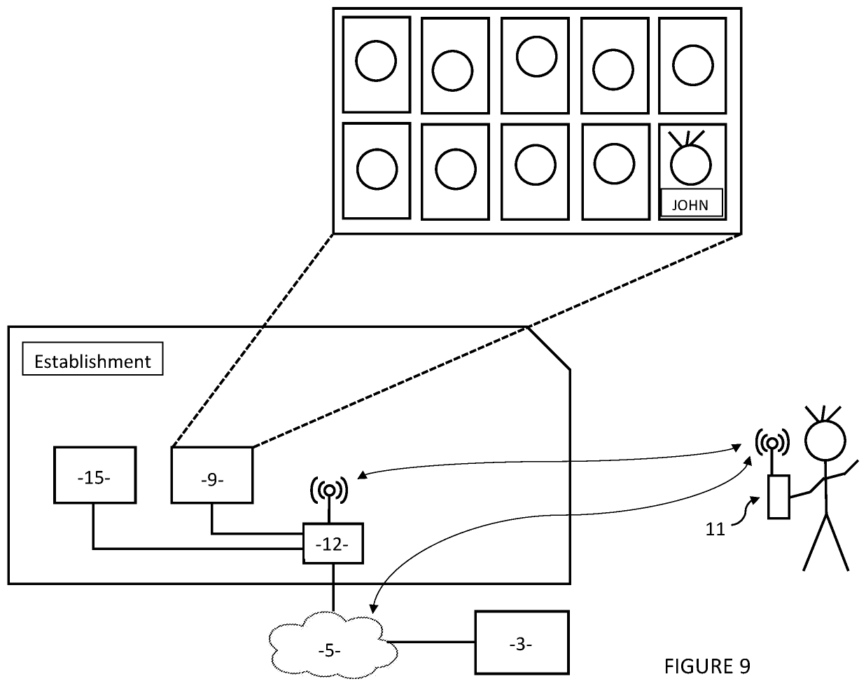

Referring to FIG. 9, the position data for each subscriber may be used by the system 1 to populate a list of subscribers currently present at or in close proximity to an establishment's location. In the embodiment depicted, the location of the subscriber is determined based upon the connection of a subscriber's communication device 11 to the Wi-Fi network of an establishment, access to which is provided by a router 12, and/or based upon position data transmitted by the mobile communication device 11 to the server 3 via the network 5. It will be appreciated other means for verifying position of a subscriber may be used as described above. The list of subscribers may be displayed on an establishment's verification devices 9 and include each subscriber's name and photograph to enable subscribers to be quickly identified on the verification device 9 by establishment staff. Since the position data for each subscriber is established or queried continuously by the system 1, the list is updated in real-time. For example, if manual verification of a check-in event is required by an establishment, an employee of an establishment may quickly identify a subscriber's presence from the list of subscribers displayed on the verification devices 9 by matching the photograph and name with the subscriber at the physical location. Thus, a subscriber may approach an employee of the establishment to confirm check-in, the employee may quickly identify the subscriber from the list displayed on the verification device 9 and trigger a verification signal including information identifying the selected subscriber to be sent by the verification device 9 to the program server 3.

Upon receipt of the verification signal, the universal loyalty program module of the program server 3 is configured to determine completion of a check-in sub-challenge and update the stored record of the subscriber to add the awarded points to the subscriber's total. Check-in could alternatively or additionally be verified by the establishment by transmitting a verification signal associated with the subscriber to the server 3 from a verification device 9. The verification signal can be associated with the subscriber by, for example, inputting of a verification code unique to the subscriber into the verification device 9 or by scanning a code, such as a QR code, displayed on the subscriber's communication device 11 and/or by selecting the subscriber from the displayed list of present subscribers. Additionally or alternatively, a machine readable indicia such as a QR code or barcode may be displayed within the establishment's premises as a printed poster or displayed on the verification devices 9 when prompted to enable subscribers to scan the code with their communication devices 11 and trigger transmission of a verification signal including subscriber identification information to the program server 3.

Since the system 1 monitors or detects the location of subscribers in real time and can determine the proximity of the subscribers to a particular establishment, the system is operable to identify subscribers that are not only at the establishment but also close to the establishment. This enables the establishment to filter its subscribers by selecting to display on the verification device 9 only those subscribers that are within a certain distance of the establishment e.g. 100 m radius. Monitoring the proximity of subscribers relative to an establishment facilitates determination of a subscriber's eligibility for certain sub-challenges and also of tailoring a sub-challenge according to the number of subscribers within a certain distance of the establishment. For example, an establishment may configure a sub-challenge to be accessible only to subscribers at or within a certain distance of the establishment, subscribers who have been at the establishment for a minimum length of time, or subscribers that were previously at the establishment but have since departed. Thus, the system 1 enables an establishment to tailor a sub-challenge to further incentivise specific subscribers to remain at the establishment or to return to the establishment.

The invitation sub-challenge relates to a social networking based challenge whereby the subscribers of an establishment program are challenged to invite one or more other subscribers of the establishment program as well as subscribers of other establishment programs to ‘check-in’ with the establishment and/or subscribe to the establishment's loyalty program and/or complete some other action such as purchase a minimum number/value of goods at the establishment. The loyalty program access module is configured to list all subscribers of all programs to enable a subscriber to quickly invite one or more subscribers to take part in the challenge. It is envisaged that the loyalty program access module may be configured to access or import details of a subscriber's contacts from one or more other software modules running on the communication device 11 such as Facebook, WhatsApp, Google+ or the subscriber's digital phonebook to enable invites to be sent to contacts that are not subscribers of the system 1.

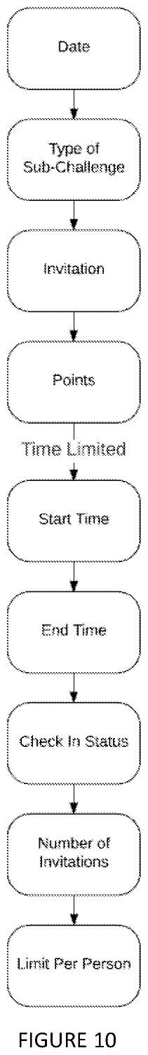

With reference to FIG. 10 the invitation sub-challenge may be configured to award a set number of virtual points per invitee to a host player and to award a set number of virtual points to a no status or invitee player, if the invite action is completed. The sub-challenge may also be configured to start and end at particular times, to require that the host player has registered for the sub-challenge prior to sending invitations, to require that an invitee or no-status player has not already received and completed the invite action and, if desired, to limit the sub-challenge to one per subscriber. The sub-challenge can also be configured to cap the number of invitees per host player and, hence, the number of points that may be awarded or to allow any number of invitees and, hence, potential points awarded. Completion of an invite action by an invitee may be verified by transmission of a verification signal to the server 3. Verification may be by any suitable means and may include verification by the verification devices 9 of the establishment after completion of the required action such as scanning or input of a host player's unique code by the establishment, identification and selection of an invitee on an establishment's verification device 9, verification based on the invitee's location as determined by the positioning means of the invitee's communication device 11, or position/connection of the invitee's communication device 11 to a wireless communication device such as a Wi-Fi router or wireless beacon and/or registration of the invitee with the establishment's loyalty program.

For an invitation sub-challenge, the system 1 is configured to enable a subscriber to send invites only when the subscriber has himself or herself checked in to the establishment. Inviting subscribers thus become host players that (subject to limitation parameters) may invite any number of subscribers to check-in with an establishment. Since host players are already checked-in, they are unable to receive invites from other host players. Each subscriber that is not checked-in may be invited to check-in by a host player. Thus, a host player may invite a subscriber that has yet to receive any invites and has not checked-in (a ‘no status’ player) or a subscriber that has already received one or more invites and has not checked-in (an ‘invitee’ player).

Upon verification of check-in by an invitee, the universal loyalty program module of the system 1 is configured to change the invitee's status to a host player who may themselves invite other no-status or invitee subscribers. The check-in sub-challenge is configured such that a host player cannot become an invitee or no-status player by simply leaving the establishment. However, the check-in sub-challenge is configured such that a host player can continue to send invites even after having left the establishment. The check-in sub-challenge is further configured such that virtual points are awarded to both the invitee and the host player even if the host player has left the establishment. The check-in sub-challenge may be further configured such that an invitee can receive virtual points for each invite received upon check-in. If the check-in sub-challenge is configured to limit the number of invites per host player, the system is configured to redeem invitations that may have been cancelled (actively or inactively), rejected, or failed to be acted upon within a set time so that the host player may send out additional invitations.

In one example, an invitation sub-challenge may be configured by an establishment to become accessible to a subscriber upon completion of a check-in sub-challenge by that subscriber, to award 50 virtual points to the subscriber upon check-in, thereby changing the status of the subscriber to a host player, and to award 25 virtual points for each subscriber that successfully check-ins in at the establishment for the next 60 minutes in response to an invitation sent by the host player. Thus, a combination of a check-in sub-challenge and an invitation sub-challenge may be configured by an establishment as part of an overall challenge to encourage subscribers to invite friends and acquaintances to the establishment, effectively turning the establishment into a social ‘hotspot’ and encouraging increased sales at the establishment.

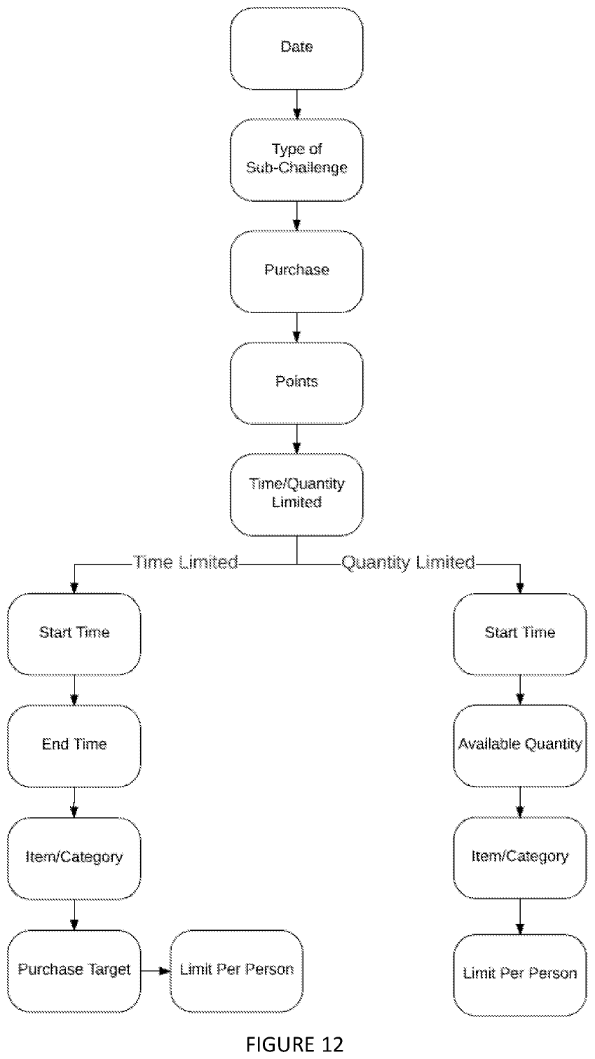

With reference to FIG. 12 the purchase sub-challenge may be configured to award points to a subscriber for purchasing specific goods and/or services from an establishment. The parameters for the purchase sub-challenge may include a start and, optionally, a stop time, a points multiplier to set the number by which the sale value of goods/services is multiplied to determine the total points award, specific items or a particular category/brand of item or any item regardless of type or category, and whether or not the sub-challenge is limited by quantity e.g. limited by the number of products that are available to be purchased.

For a purchase sub-challenge configured with a start time only, the default configuration is that the sub-challenge ends at the end of the day on which the sub-challenge is initiated unless the stock of product that is the subject of the sub-challenge is depleted before then. For example, for a time limited sub-challenge, an establishment could configure a purchase sub-challenge that starts at 21:00 and finishes at 23:00 with double points awarded for the purchase of a particular brand of alcohol during that period. Alternatively, for a quantity limited sub-challenge, an establishment could configure a purchase sub-challenge that starts at 21:00 with double points awarded for the purchase of a particular brand of alcohol up to a limit of 10 individual items. Advantageously, an establishment can configure a purchase sub-challenge to promote sale of items that may be overstocked, about to expire, or launching for the first time in the marketplace.

Since the system 1 has a default fixed ratio of one virtual point for every set unit of currency spent, the chosen points multiplier determines the total number of virtual points awarded for the purchase of a specified item. For example, if a sub-challenge is configured such that a specific item is chosen to be “boosted” which costs $50 HKD (as known by the system 1 due to information transmitted from the point of sale system) and the points multiplier is set at 3 i.e. triple points, a subscriber will receive a total of 150 points i.e. 3×50 upon completion of a purchase of the specific item. Thus, in this example, the total of 150 virtual points awarded for a triple point purchase sub-challenge comprises the 50 standard virtual points and 100 additional points due to the points multiplier.

Verification of completion of a purchase sub-challenge may be made by any suitable means and may include verification using the verification devices 9 of the establishment upon purchase or order of one or more qualifying items which causes a verification signal including information identifying the subscriber and the purchased items to be sent to the program server 3 for processing by the universal loyalty program module to determine completion of the sub-challenge and to update the subscriber's points total. As above, an establishment may quickly determine the identity of a subscriber for swift verification purposes using the real-time list of subscribers determined by the system to be present at the establishment's location and displayed on the establishment's verification devices.

The verification process may take place in multiple steps whereby the verification device 9 registers and transmits a signal to the server 3 that a qualifying order has been placed and which can be completed at a later stage. This allows subscribers to ensure they can “reserve” one or more redemptions and have the option to pay later at their leisure. Upon payment for the order, the verification signal may be transmitted to the program server 3 so that the universal loyalty program module of the system 1 can process the points award and update the subscriber's cumulative total. The payment, redemption, and point assignment steps can occur even after the sub-challenge has expired but before close of business on the day of the sub-challenge. The system 1 is configured such that when a qualifying order has been placed, a subscriber can view their account and verify that the points reward (including points to be awarded) has been tentatively redeemed pending payment for the order. Thus, a subscriber can order goods during a sub-challenge period, for example with a bar tab, and obtain the points award when settling the bill at the end of the evening.

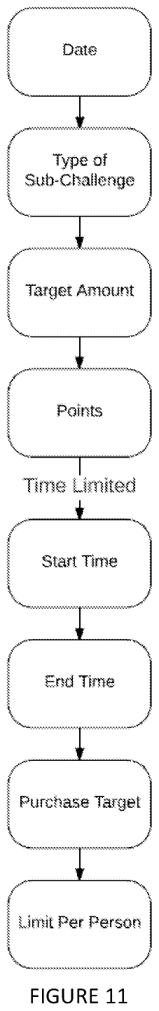

With reference to FIG. 11 the target amount sub-challenge may be configured to award points to a subscriber for spending a minimum amount for goods and/or services from an establishment or a multiple thereof. The parameters for the purchase amount sub-challenge may include a start and stop time or be pre-set to an entire business day, a number of points to be awarded per minimum spend or target amount and the threshold minimum spend amount/target amount. For example, an establishment could configure a purchase amount sub-challenge that starts at 09:00 and finishes at 22:00 with 100 points awarded per $1,000 spent with an establishment. Thus, if a subscriber spends $10,000 with an establishment whilst the target amount sub-challenge is active, the subscriber will be awarded the standard 10,000 points and an additional 1,000 points in accordance with the terms of the sub-challenge. Advantageously, an establishment can configure a target amount sub-challenge to encourage the purchase of goods and/or services on days and times where business is usually slow.

Verification may be by any suitable means and may include verification using the verification devices 9 of the establishment to generate and transmit a verification signal to the universal loyalty program module of the program server 3 upon purchase of goods and/or services with a combined value greater than the set minimum spend or multiple thereof. As above, verification may be achieved more quickly using the list of subscriber's indicated on the verification devices 9 as being present at the establishment's location thereby enabling the identity of the purchasing subscriber to be determined more quickly. Again, verification may be a multi-stage process whereby an order is placed that qualifies for redemption but points are not awarded until completion of a purchase at a later point in time even after the sub-challenge has ended. Verification of completion of the sub-challenge causes a verification signal to be sent to the universal loyalty program module of the program server 3 to update the subscriber's points total.

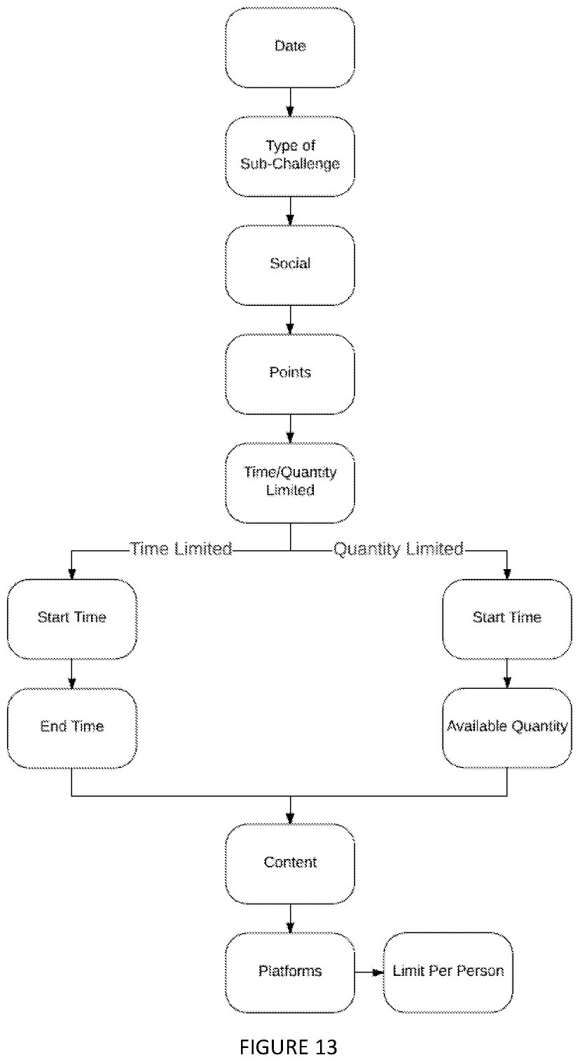

With reference to FIG. 13, the social sub-challenge may be configured to award a set number of points for completing a particular social media based activity. Thus, the social sub-challenge permit establishments to reward subscribers for sharing particular forms of media (links, pictures, videos, comments, or any combination thereof) through the subscriber's social media accounts and thereby promote the establishment's business. The sub-challenge may be configured to start and end at particular times or to be quantity limited and the type of action that must be taken to be awarded the virtual points may be set. In the embodiment depicted, three types of social media content to be shared may be set by the establishment for sharing in return for virtual points. One type of content to be set by the establishment is a comment for subscribers to share on social media, a second type of content to be set by the establishment is a picture or video to be shared by subscribers, and a third type of content to be set by the establishment for sharing is a website link. The social sub-challenge is also configured to specify the social media channels through which the content must be shared by subscribers in order to be awarded points. The available social media channels are set by the system operator and may include all popular platforms including Facebook, Twitter or Instagram. It will be appreciated that this is a non-exhaustive list and that other social media channels may be made available as desired. By default, the social sub-challenge is set to reward subscribers for sharing the specified content on all social media channels available to the system 1. Finally, the sub-challenge may be configured to specify how many times a subscriber may complete the sub-challenge. In the case of a social media sub-challenge, this by default is set to once per person.

Since sharing requires subscriber's to use their own social media accounts, subscribers are required to link their social media accounts to their corresponding system 1 accounts in order to be eligible to obtain virtual points for completing social sub-challenges. The social sub-challenge is configured to award virtual points for every social media platform through which a subscriber shares the specified content. For example, a social sub-challenge may be configured to award fifty virtual points per social media platform through which a video and a specific comment are shared. If a subscriber shares the specified video and comment on three different social media platforms specified by the social sub-challenge, the subscriber would be awarded a total of 150 points.

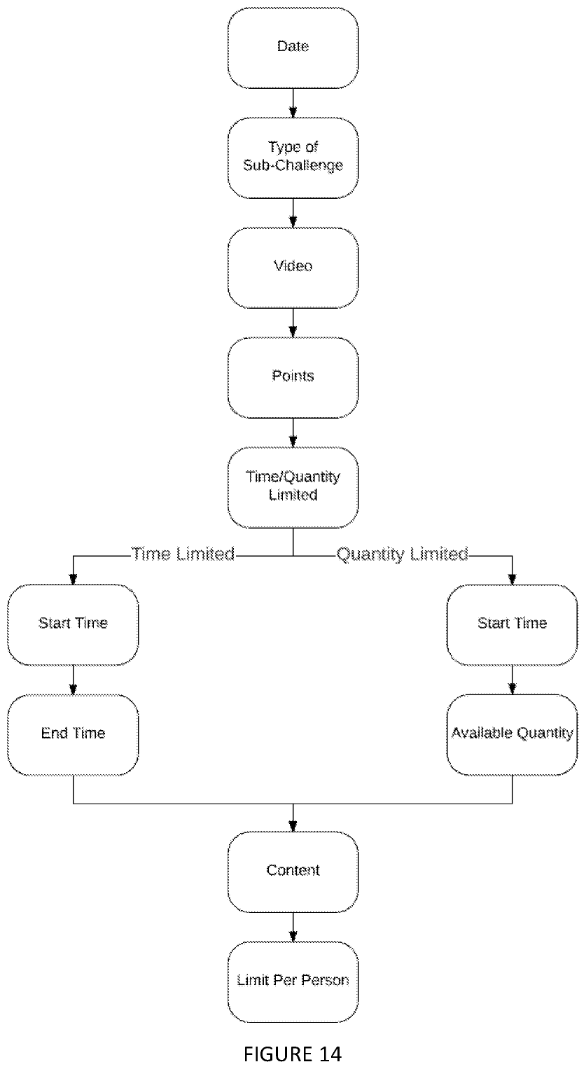

With reference to FIG. 14, the video sub-challenge may be configured to award a set number of points for subscribers to view a video identified by an establishment, such as an establishment's promotional video, a third party's promotional video or the system operator's promotional video. The sub-challenge may be configured to start and end at particular times or to be quantity limited. The link that must be shared in order to qualify for the virtual point redemption is then specified. Finally, the sub-challenge is configured to specify how many times a subscriber may complete the sub-challenge. In the case of a video sub-challenge, this by default is set to once per person.

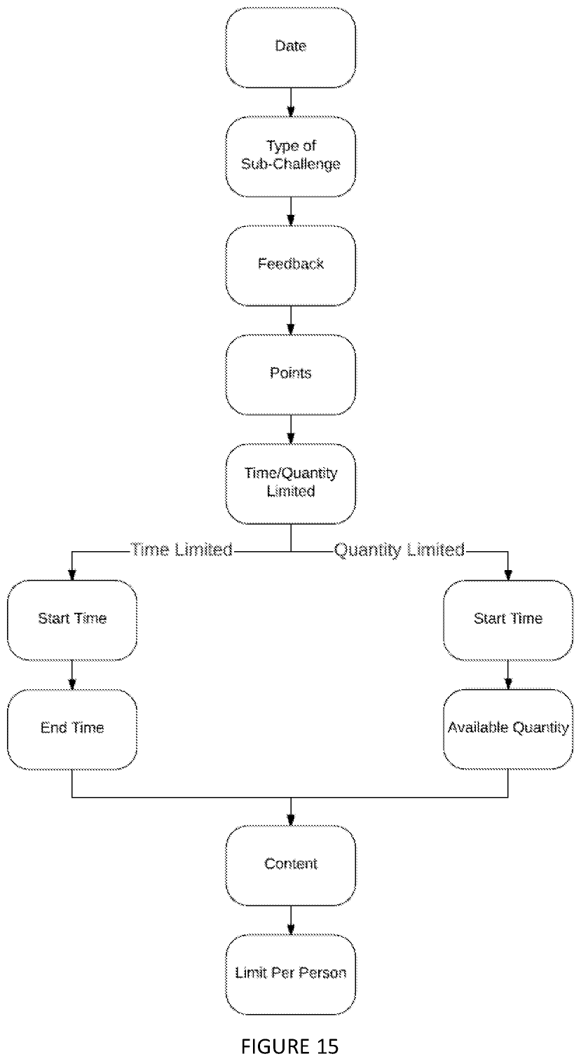

With reference to FIG. 15 the feedback sub-challenge may be configured to award a set number of points for providing feedback by completing a predefined survey or providing a comment about the establishment. The sub-challenge may be configured to start and end at particular times or to be quantity limited. The survey link is then specified to enable subscribers to access the survey and provide their feedback which is received by the server 3 and stored in memory. Finally, the sub-challenge is configured to specify how many times a subscriber may complete the sub-challenge. In the case of a feedback sub-challenge, this by default is set to once per person.

A knowledge based sub-challenge may be configured to award a set number of virtual points for completing one or more questions of, for example, a quiz. The knowledge sub-challenge may comprise one or more questions provided by the establishment or by a third party. The questions may be tailored to promoting a brand or particular products or services or may be non-specific. Either way, the purpose of the knowledge sub-challenge is to engage patrons of an establishment. In the example of a quiz set by an establishment, the knowledge sub-challenge may be configured to award 50 virtual points for every correct answer, and/or 50 virtual points for completion of the quiz, and/or 50 virtual points to be the first to complete the quiz. It will be appreciated that many variations are possible.

Verification of completion of a social, video, feedback, or knowledge sub-challenge for redemption of points may be automatically determined by the system 1. In particular, if the action required to complete the sub-challenge is made through the web application or loyalty program access module of the system 1, the universal loyalty program module of the system 1 can determine completion of the sub-challenge upon receiving a verification signal with information confirming sharing of a specified website link, picture, video or comment, viewing of a particular video or submission of a completed survey or comment. Upon completion of the sub-challenge, the universal loyalty program module of the system 1 will update the subscriber's account with the specified virtual points award and, in the case of a person limited sub-challenge, update the subscriber's account such that the sub-challenge is no longer accessible to that subscriber.

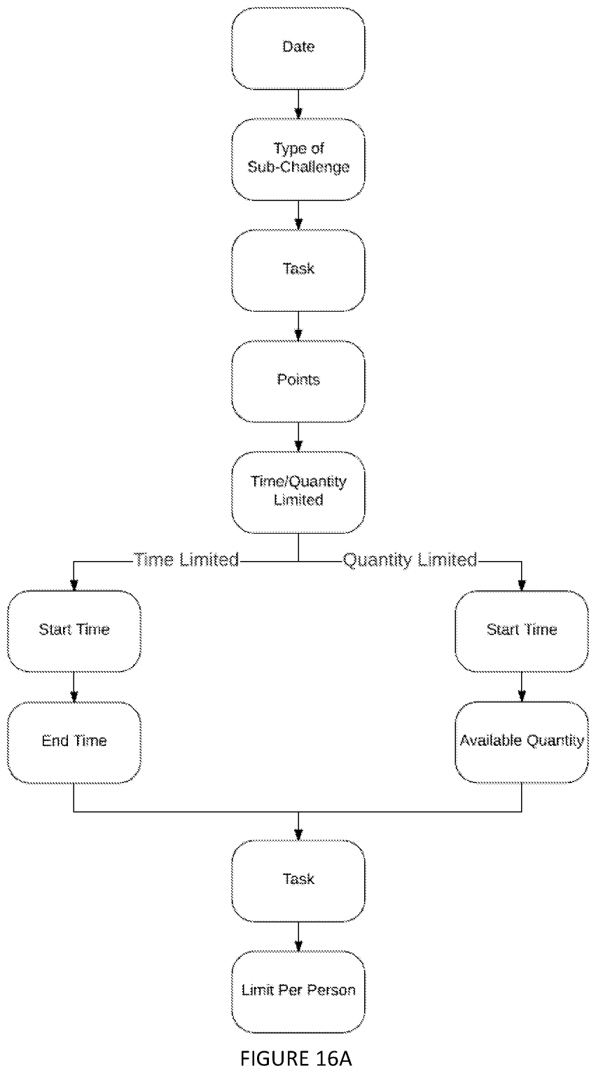

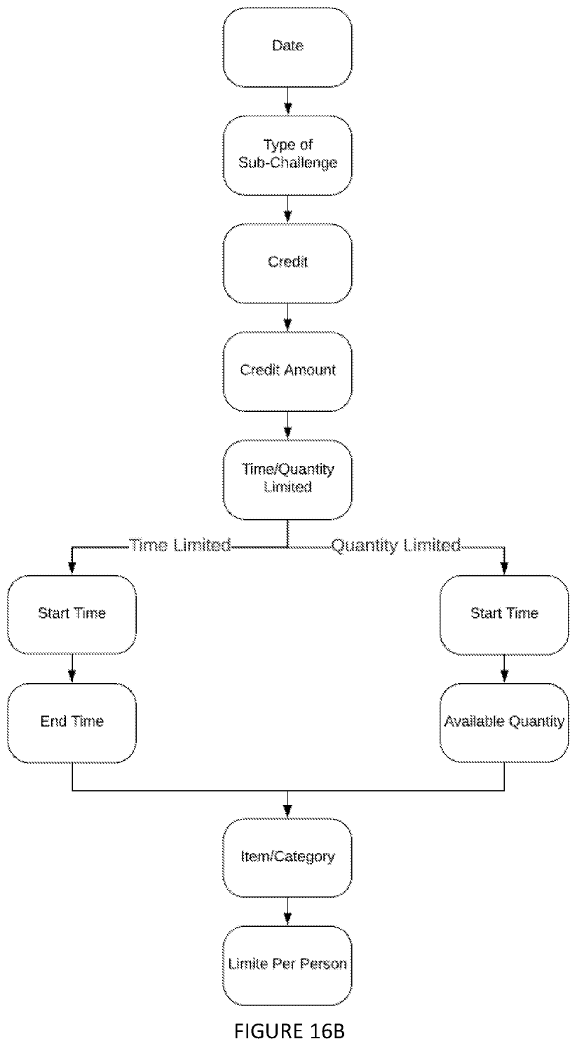

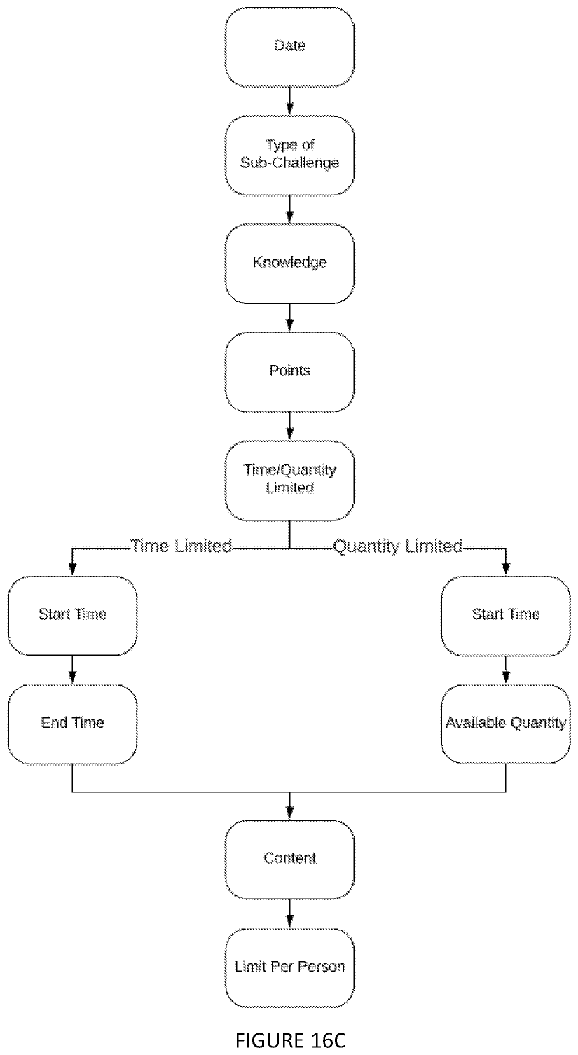

With reference to FIG. 16A, the tasks sub-challenge may be configured to award points to a subscriber for completion of various different tasks requiring manual verification of completion by establishments. The parameters for the tasks sub-challenge may include a start and stop time, details of the task to be completed, any limit on the number of times the task may be completed by the subscriber, and a number of points to be awarded for completion of the task. For example, an establishment could configure a tasks sub-challenge to start at 18:00 and end at 21:00 with 100 points awarded per completed task. The establishment can choose any task including but not limited to wearing a particular item of clothing when attending an establishment venue, locating a particular item (real or virtual) in the establishment, visiting as many of the establishment's venues as possible, singing at an open mic night or participating in a trivia challenge. Advantageously, an establishment can configure a tasks sub-challenge to encourage attendance at the establishment venues, add an extra element of fun to the overall challenge and engage subscribers/customers to help promote the establishment through viral marketing.

Verification of completion of a task sub-challenge may be by any suitable means and may include verification by the verification device 9 of the establishment upon completion of the task. As above, since subscribers' location is tracked by the system 1 in real-time, establishments may quickly identify subscribers that are present at an establishment or other location on a verification device 9. An employee may manually verify completion of a task sub-challenge by a subscriber by locating their details on the verification device 9, scanning an identification means unique to the subscriber, or any other suitable identification means. Verification of completion of the task causes a verification signal to be sent by the verification device 9 to the program server 3 where, upon receipt, the universal loyalty program module updates the subscriber's stored points total.

The system 1 is configured to permit third party vendors to incentivise establishments to promote their goods, services, or brand(s) with purchase sub-challenges or credit sub-challenges (FIG. 16B), or any other appropriate sub-challenges. The system 1 may optionally allow third party vendors to access the system 1, upload product lines and indicate which product lines are available to be “boosted” or promoted in a sub-challenge in return for payment of a fee for each item sold.

For example, a third party vendor engaged with the system of the present disclosure for a relevant sub-challenge may upload its product line to the system 1 and the establishment/vendor can specify which items are eligible to be “boosted” in this challenge. On this basis, following the sub-challenge (e.g. purchase sub-challenge culminating in the award of points), the establishment will have the ability to identify the product items of an engaged third party vendors have been sold during that sub-challenge, and which therefore which generated an obligation on the third party to pay the establishment. It would be appreciated that the type of sub-challenge could be any one of those previously described, including a credit sub-challenge culminating in the award of store credit.

Thus, establishments will be incentivised to promote third party vendor products with an appropriately selected sub-challenge—(see e.g. FIGS. 10-16C).

Video sub-challenges provide establishments with a means to generate advertising revenue by generating views from their own subscriber base for a third party's latest promotional video. Thus, when creating a video sub-challenge, the system 1 is configured to permit an establishment to choose a video of its own (either newly uploaded or previously uploaded to the system server 3), use one of the system operator's promotional videos, or select a third-party vendor video located on the program server 3. As with the purchase sub-challenge, the system 1 may be configured to enable third party vendors to upload video content for promotional use and to specify a fee per view to be paid to establishments in order to encourage establishments to promote the third party video to the establishments' loyalty program subscriber base.

The system 1 also provides establishments with the option to create third party specific social, feedback, knowledge, or task based sub-challenges whereby subscribers are incentivised to promote the third party's goods or services via social media, or to provide survey feedback, take part in a knowledge based game, or to complete certain third party related tasks, in return for virtual point awards.

As above, establishments may be incentivised to promote a third party's products and services in return for payments from the third party. Accordingly, the universal loyalty program module of the system 1 is configured to determine when a third party's goods and services have been used as the basis of a particular sub-challenge by an establishment and to reward the establishment accordingly. Since the system 1 is configured to provide establishments with the ability to generate revenue by providing third parties with access to an establishment's customer base, the system 1 may be configured to charge a fee either as a fixed amount or as a percentage of revenue generated by an establishment.

Advantageously, this additional feature of the system 1 permits new companies to gain exposure to the market and build a customer base, permits established companies to promote new product lines or brand campaigns, or enables companies to boost declining reorder sales from establishments.

In addition to sub-challenges, the universal loyalty program module of the system 1 is configured to provide establishments with the option to offer bonus incentives as part of an overall challenge to further engage subscribers and encourage participation in the overall challenge. Bonus incentives may comprise store credit, non-monetary prizes, or access to certain ‘locked’ incentives or prizes such as access to higher level sub-challenges with the potential for obtaining greater virtual points rewards. The bonus incentives may be rewarded to a participating subscriber by the system 1 upon hitting specified milestones such as a threshold number of virtual points. When a bonus incentive milestone is reached, the loyalty program module of the system 1 updates the stored record of the participating subscriber to associate the reward obtained with that subscriber's account for future redemption.

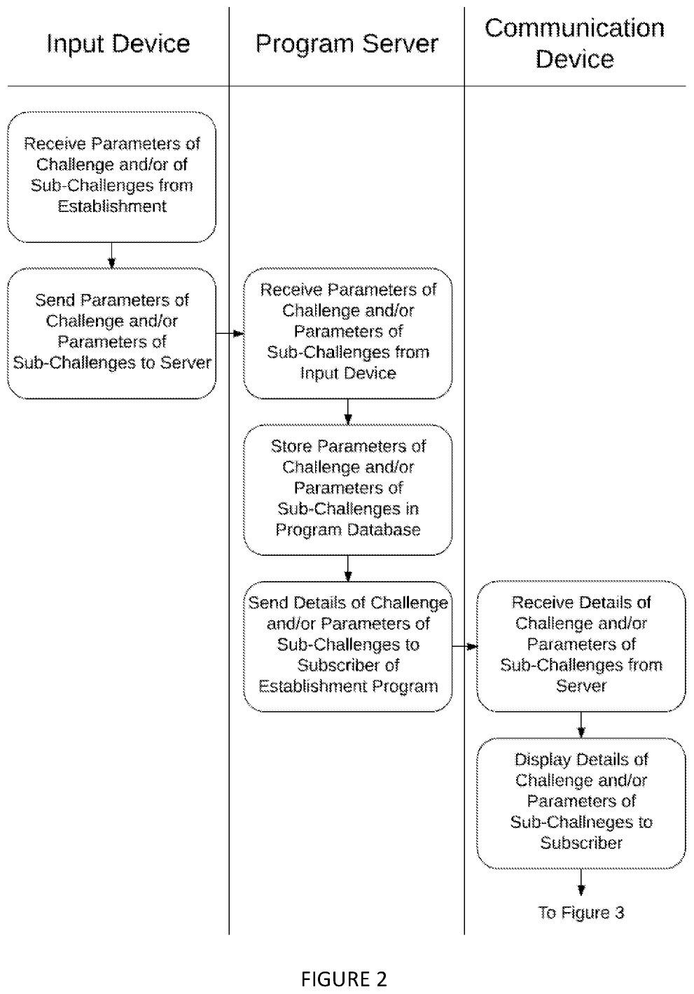

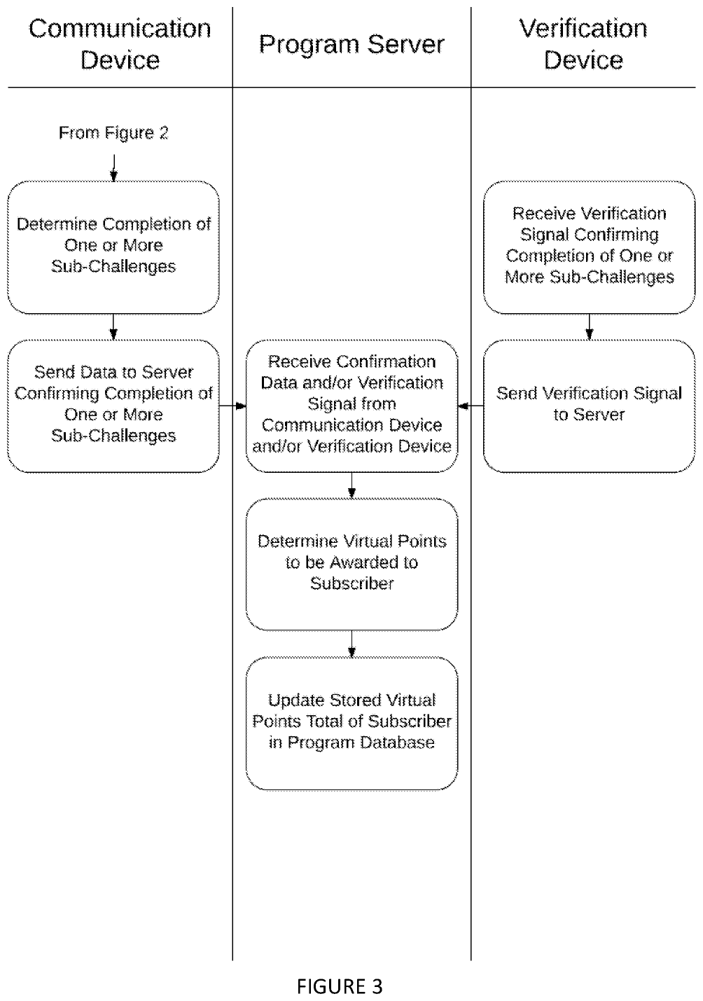

With further reference to FIGS. 2 and 3, an establishment can create a bespoke overall challenge for a loyalty program to incentivise subscribers to buy goods and services from the establishment and actively promote the establishment. The establishment accesses its account via an input device 7 and inputs parameter data for an overall challenge into the input device 7 based on duration (start date and end date), winners as a percentage, prize fund as a percentage of spend during the overall challenge, and winner differential. Optionally, the establishment may configure the loyalty program to offer cashback or store credit independently and alongside the overall challenge and even when no overall challenge is currently active. A field for each variable is provided either by a webpage downloaded to the input device 7 via the network 5 or by an input module stored on the input devices 7. The establishment can also input parameters for one or more sub-challenges to further incentivise subscribers to take part in the overall challenge. One or more sub-challenges may be created at the time of creating the overall challenge or subsequent to creation of the overall challenge through a webpage displayed on an input devices 7 or an input module (software application) stored on the input devices 7. Parameters of the overall challenge and sub-challenge may be changed throughout the overall challenge via one or more webpages or mobile application on the input devices 7.

Upon input of the parameters of the overall challenge and/or one or more sub-challenges and confirmation of the parameters by the establishment, the input device 7 sends the parameters as data to the program server 3 for further processing. The program server 3 receives the parameter data and the universal loyalty program module instructs the program server 3 to store the parameter data in the program database. The universal loyalty program module of the program server 3 determines the start date and time for the overall challenge and/or one or more sub-challenges, determines the subscribers of the establishment's loyalty program and transmits details of the overall challenge and/or one or more sub-challenges to the subscribers and/or associates the challenge with the account of the respective subscribers when the start date and time of the overall challenge and/or one or more sub-challenges is reached. Additionally or alternatively, the establishment itself may transmit, by or more computing devices, details of the overall challenge or one or more sub-challenges to subscribers of the establishment's loyalty program.

Upon receipt of details of the overall challenge and/or one or more sub-challenges by a subscriber's communication device 11 or upon logging into the subscriber's account registered with the system 1, the communication device 11 displays details of the overall challenge and/or one or more sub-challenges. Display of details of the overall challenge and/or one or more sub-challenges may be triggered automatically by a loyalty program access module stored on a communication device 11 of a subscriber such as a smartphone upon receipt of details of the challenge or sub-challenge.

As outlined above, a subscriber may purchase goods or services from an establishment throughout the duration of the overall challenge to earn virtual points in addition to the specified cashback or store credit offering. At the point of sale, a subscriber unique identification such as a code or machine readable indicia may be scanned by or input into a verification device 9 which may be a tablet computer or point of sale terminal. Additionally or alternatively, since a subscriber's location is automatically detected upon entry into an establishment (via location services or some form of fencing service such as Bluetooth beacons, or Wi-Fi, or other suitable method) and the list of subscriber's “checked-in” is updated by the system, an establishment verification device 9 such as a point of sale machine or dedicated computing device will automatically show details of the subscriber on screen for quick identification. Additionally or alternatively, one or more computing devices with facial recognition capability may be located in or around the establishment for quick identification of subscribers. It will be appreciated that the verification device 9 may be the same computing device used by the establishment to access its merchant account with the system 1 and input overall challenge and sub-challenge parameters i.e. the same device as the input device 7. With further reference to FIG. 9, the establishment employee may locate the subscriber within the displayed group of checked-in users (a dynamic group updated real-time) and initiate verification upon purchase of goods or services by selecting the subscriber via username, picture, and if needed a subscriber unique identification.

The verification device 9 transmits a verification signal including details of the purchase together with details of the subscriber as determined by the code or machine readable indicia or selection of the subscriber from the displayed group to the program server 3 for processing by the universal loyalty program module. Upon receipt of the purchase details, the universal loyalty program module of the program server 3 determines completion of the sub-challenge and the number of virtual points to be awarded to the subscriber as dependent on the parameters of the overall challenge, or (as appropriate) the amount of store credit to be awarded to the subscriber as dependent on the parameters of the appropriate sub-challenge (e.g. credit sub-challenge or 3rd party credit sub-challenge). The universal loyalty program module of the program server 3 then updates the stored record of the subscriber in the program database to add the awarded virtual points to the subscriber's total.

A subscriber can attempt to complete one or more sub-challenges of the overall challenge to earn additional virtual points or earn store credit. Whether or not the subscriber is eligible to take part in a sub-challenge and how they take part is determined in real-time by the universal loyalty program module of the system 1. The system 1 is configured such that only those sub-challenges that the subscriber is eligible or could be eligible to take part in will be shown/accessible to the subscriber. Sub-challenges may be grouped into those that the subscriber is eligible to take part in, those that the subscriber could become eligible to take part in if he/she performs a certain action e.g. checks-in to an establishment to become a host player, and those that the subscriber will never be eligible for and, hence, will not be shown. For example, in the case of an invitation sub-challenge, the system 1 will not display the invite option to a subscriber on their communication device 11 until they have checked-in at the specified location and may thus become a host player. Likewise, the system 1 will not permit a host player to receive invites. Quantity limited sub-challenges which have already been completed by a subscriber for the allotted number of times will also no longer be displayed to subscribers.

The method of verification of completion of a sub-challenge may depend on the type of sub-challenge as described above. In respect of a check-in sub-challenge, verification may be confirmed automatically based upon signals received by the program server 3 indicating the position of a subscriber's communication device 11 in proximity to the sub-challenge venue e.g. establishment's location. As described, the location of a subscriber's device may be tracked in real-time via GPS location, Wi-Fi positioning and/or beacon positioning systems or sensors. Verification may also be triggered by one or more computing devices with facial recognition technology. Verification of check-in may additionally or alternatively be manually confirmed by an employee of an establishment via a verification device 9 by inputting or scanning of a code which is unique to the subscriber or selection of the subscriber on the verification device 9 from the list of subscriber's determined by the system 1 to be present at the sub-challenge check-in location and the transmission of a verification signal to the program server 3 for processing by the universal loyalty program module.

The verification of completion of one or more task, purchase, or target amount sub-challenges may be completed using a verification device 9 of an establishment facilitated by real-time location tracking which enables quick identification of subscribers at the point of completion of a sub-task e.g. purchase of goods at a point of sale terminal verification device 9. As above, upon completion of a sub-challenge e.g. wearing a red jumper to an establishment, an employee of the establishment may input or scan a code unique to the subscriber via the verification device 9 and/or select the subscriber from the list of subscriber's populating the checked-in list of the establishment as displayed on the verification device 9. The establishment may then transmit the verification signal including subscriber information and confirmation of completion of a sub-challenge via the verification device 9 to the program server 3 for processing by the universal loyalty program module.

Upon receipt of the verification signal, the universal loyalty program module of the program server 3 determines completion of the sub-challenge and updates the subscriber's stored record on the loyalty program database to add the virtual points award to the subscriber's total.

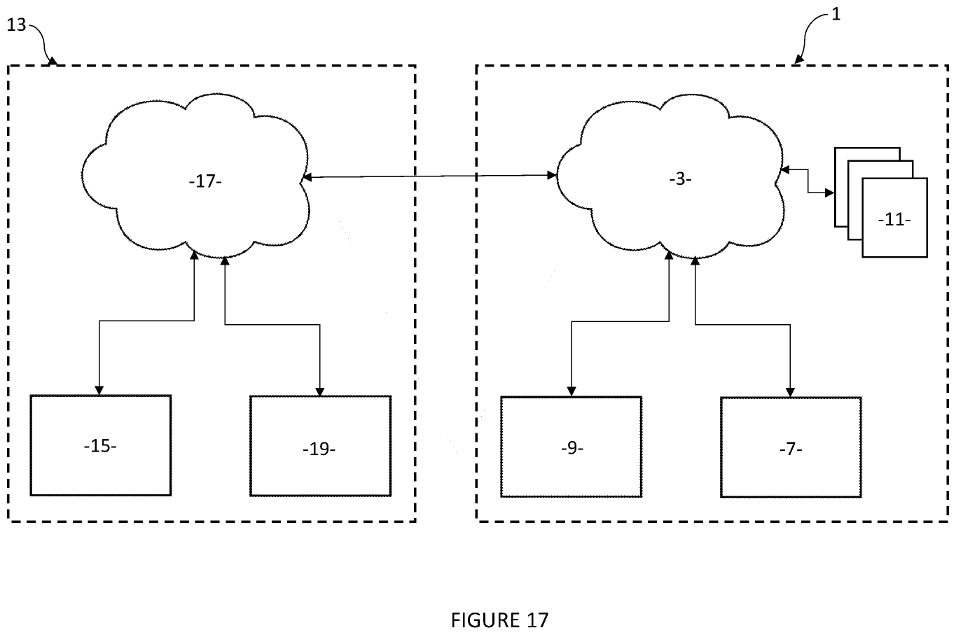

Referring to FIG. 17, to facilitate verification of completion of a sub-challenge or of the award of cashback/store credit, and also to enhance the customizability of sub-challenges, the system 1 is configured to interface with an establishment's point-of-sale system 13 which stores item and pricing information. PoS systems typically comprise one or more PoS machines 15 configured with software to communicatively link the PoS machines to one or more computing devices of a cloud based server 17 storing data related to the PoS system. A PoS system 13 may be the establishment's own proprietary system or provided by an external PoS service provider. The PoS system 13 enables the establishment to create an account and to upload or create a menu or inventory list with associated identification data and pricing information. For example, a restaurant establishment may create a menu list which includes all available food or drink items that may be ordered, each with a corresponding identification code and price.

The establishment may access its PoS merchant account via any computing device 19 with an internet connection so that the establishment can customize its account, and create or amend its menu or inventory list. The PoS machines 15 access the menu/inventory list so that one or more individual items from the list can be identified by the establishment when an order is being entered into the PoS system 13. This identification process may involve manually selecting each ordered item via a PoS machine 15 using a PoS user interface, which may comprise a touchscreen display and/or a keyboard, or scanning a machine readable code affixed to a particular item. Upon confirmation of an order, details of the order are transmitted to the PoS server 17 for storage and are associated with a unique order identification number.

The universal loyalty program module of the system 1 is configured to interface with the PoS system 13 and link the establishment's system 1 account with its PoS merchant account. By linking the two accounts, the system 1 is able to access the establishment's menu/inventory list to be stored on the program server 3. The universal loyalty program module is configured to query the PoS system 13 for the latest menu/inventory list either automatically or upon manual request by a user of the system 1. To facilitate a manual query, the loyalty program module is configured to display a user actuable ‘sync’ button on the system web manager or input module which may be selected after logging in to the establishment's account via an input device 7. The loyalty program module is configured to query the PoS system 13 upon selection of the sync button by an establishment to obtain the most up-to-date inventory/menu list and store the list on the program server 3.

Having access to the establishment's menu/inventory list via the establishment's system 1 account enables the establishment to select specific items or item categories to be boosted via a sub-challenge. For example, a restaurant may use an input device 7 to access the universal loyalty program module via a web manager and create a purchase sub-challenge of an overall challenge. The establishment may select a particular item from its menu as stored on the program server 3 and associate an additional reward with the selected item. Thus, the selected item is ‘boosted’ by the purchase sub-challenge by incentivising subscribers to purchase the selected item.

In addition to enhancing the customizability of sub-challenges, the interaction between the system 1 and an establishment's PoS system 13 facilitates association of orders with subscribers. As described above, the PoS system 13 assigns a unique order identification number to a subscriber's order and stores this information on its cloud based web servers 17 together with details of each ordered item. Upon creation of an order in the PoS system 13, the universal loyalty program module is configured to receive this order information, including the unique order identification number and identification code of each ordered item, by one or more computing devices of the program server 3 and to transmit an alert signal to the verification device 9 of the establishment requesting identification of the subscriber for the order as identified by the unique order identification number. Upon receiving the alert, the establishment selects the appropriate subscriber from the list of subscribers via the verification device user interface and transmits a verification signal back to the program server 3 so that the universal loyalty program module can associate the order with the selected subscriber's account and update the stored record of the subscriber on the loyalty program database to include the corresponding reward.

Since the system 1 has the price information of each item on the establishment's inventory/menu, the system 1 is operable to calculate the total order cost based on the ordered items and to tentatively credit the subscriber with the appropriate amount of store credit and rewards according to the parameters of an overall challenge and active sub-challenges. For example, if an overall challenge has been configured to offer 1% cashback or store credit, and two active sub-challenges are in play, namely a purchase sub-challenge for a particular category and a target amount sub-challenge, the system 1 uses the order information received from the PoS system to calculate the total order amount, calculate the amount of store credit for the order amount, determine whether the total order amount exceeds the threshold for the target amount sub-challenge, and to determine whether any of the ordered items are in the category boosted by the purchase sub-challenge. The system 1 then updates the subscriber's account stored on the system database to tentatively include the calculated store credit, and to tentatively include any rewards for either of the two sub-challenges if determined by the system 1 to have been completed.

If the subscriber changes an existing order before payment, the establishment makes any necessary changes via the PoS device 15 for transmission to the PoS cloud based servers 17 so that the order information associated with the unique order identification number can be updated by the PoS system 13. The updated order information is pushed by the PoS system 13 for receipt by one or more computing devices of the program server 3. Upon receipt of the updated order information, the universal loyalty program module recalculates the store credit and rewards according to the revised order and updates the record associated with the subscriber of the order. Since the unique order identification number is already associated with the subscriber on the system 1, there is no need for the universal loyalty program module to initiate a new request for identification and verification of the subscriber.

The store credit and rewards are permanently credited to the subscriber's account when confirmation of payment is received by one or more computing devices of the program server 3 from the PoS system 13. In processing payment, the PoS system 13 may query the universal loyalty program module to obtain the amount of store credit associated with the subscriber in question. This store credit information gives the subscriber the option of paying all or part of the order using previously accumulated store credit with the establishment. Confirmation of payment (with or without accumulated store credit) is transmitted by the PoS device 15 to the PoS system servers 17 for onward transmission to the system program servers 3. Upon receipt of the payment confirmation for a unique order identification number by one or more computing devices of the program server 3, the universal loyalty program module updates the stored record of the subscriber to permanently credit the subscriber's account and any store credit used in the transaction is deducted from the subscriber's stored cumulative total. As above, since the unique order identification number is already associated with the subscriber on the system 1, there is no need for the universal loyalty program module to initiate a new request for identification and verification of the subscriber for a particular order.

While verification may be initiated by manual entry into one or more verification devices 9, for certain sub-challenges, it is envisaged that verification may be completed automatically without manual intervention by an employee of an establishment. For example, where a verification device 9 is a point of sale terminal, the point of sale terminal may be configured to automatically transmit details of a transaction and the identity of the subscriber to the program server 3 for processing, even without manual selection or identification of the subscriber on the point of sale terminal. The universal loyalty program module of the program server 3 may be configured to determine whether there is an active sub-challenge and whether or not any of the goods or services purchased by the subscriber satisfy the criteria of an active sub-challenge for a virtual points award. If the universal loyalty program module of the program server 3 determines the transaction does qualify for a virtual points award, the universal loyalty program module calculates the number of points to be awarded and updates the subscriber's stored account in the loyalty program database accordingly.

Another example of automatic verification may involve a social media related sub-challenge in which subscribers are challenged to encourage friends and acquaintances to subscribe to the establishment's loyalty program. This may involve the subscriber using a communication device 11 to send a URL link with a string unique to the subscriber to a friend inviting the friend to subscribe to a loyalty program of an establishment. Upon following the link, a loyalty program access module on the invitee's communication device may be launched, or a web page may be downloaded to the invitee's communication device from the program server 3 or some other server storing the web page to enable the invitee to subscribe to the establishment program. The universal loyalty program module of the program server 3 may be configured to determine whether or not the invitee subscribed to the establishment program, based on the unique code determine which subscriber sent the invitation, calculate the number of virtual points to be awarded to the subscriber and update the subscriber's account to reflect the new points total.

It will be apparent to a person skilled in the art that other means for automatic verification may be implemented without the need for manual intervention by the establishment and without making the verification process overly onerous or taxing for the subscribers.

The system enables an establishment to amend the points or credit awarded for a particular transaction or completion of a sub-challenge in the event an error is made.

The universal loyalty program module of the program server 3 maintains a ranking of subscribers in order of total virtual points and updates the ranking when a subscriber earns additional virtual points. The ranking is accessible by each subscriber via a communication device 11 which displays the ranking so that subscribers can determine where they are in relation to other subscribers and how many additional virtual points are required to win a prize or move up the ranking. The universal loyalty program module of the program server 3 is configured to determine the current prize award based on the parameters of the overall challenge and to indicate in the ranking the value of the prize available for each position. For example, the universal loyalty program module of the program server 3 may determine how many virtual points a subscriber is behind each prize winner and the size of the prize available for moving up the ranking. Advantageously, by providing subscribers with their real-time ranking, the possible prizes available and the number of additional virtual points required to obtain a prize or a higher prize, subscribers are incentivised to take part in the overall challenge and sub-challenges to generate new business for the establishment.

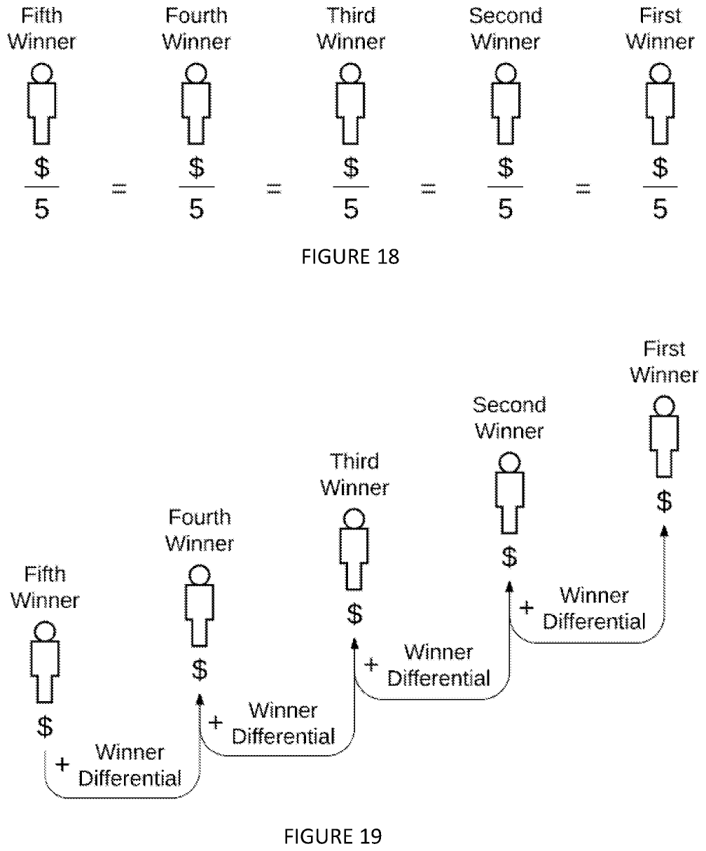

While it is possible to offer a single prize to the best performer, in an exemplary embodiment it is envisaged that a share of the prize would be made available to a larger number of subscribers to engage more than a select few that achieve far higher points than lower spending/participating subscribers. This may be achieved by configuring the overall challenge to offer a prize to a fixed number of participating subscribers or a percentage of the total number of participating subscribers. The overall challenge may also be configured to offer pre-determined prizes such as a lump sum cash payment and/or one or more non-monetary prizes, or a prize which increases with participation by subscribers, for example, by selecting the prize to be a percentage of the total gross sales made to participating subscribers. The overall challenge may be configured such that the prize is distributed equally to a fixed number of winners in a baseline model, as shown in FIG. 18 or, with reference to FIG. 19, distributed using a winner differential model to offer a greater portion of the prize to participating winning subscribers who achieve a greater number of virtual points during an overall challenge than other participating winning subscribers.

An advantage of distributing the prize based on a winner differential is that it incentivises subscribers to continue to take part in the overall challenge even after having entered into a prize winning position in the ranking. A proposed method of allocating the prize of the overall challenge to winners is described by the equation:

$${N}_{( t , b )} = \frac{{sg ( d + 1 )}^{b - 1}}{{\sum }_{x = 0}^{t - 1} {( d + 1 )}^{x}}$$

where N_{(t,b)} is the prize pay-out to a winning subscriber as dependent on their position in the overall ranking, d is the winner differential which is a variable percentage value that represents the difference in the amount of prize a given winner receives from either their next higher or next lower neighboring winner, s is the percentage of the gross sales to all subscribers throughout the entire duration of the overall challenge to be allocated to the prize fund, g is the total gross sales made during the overall challenge by subscribers, t is the number of winners, and b is the ranking of each winner where the highest ranking number is equal to the total number of winners and the lowest ranking number is equal to 1 and each other ranking is an integer therebetween.

For example, in an overall challenge configured to share the prize with the top three performing subscribers, the pay-out to the first, second, and third subscribers is determined as follows:

### First Winner

$${N}_{( 3 , 3 )} = \frac{{sg ( d + 1 )}^{2}}{{( d + 1 )}^{0} + {( d + 1 )}^{1} + {( d + 1 )}^{2}}$$

### Second Winner

$${N}_{( 3 , 2 )} = \frac{{sg ( d + 1 )}^{1}}{{( d + 1 )}^{0} + {( d + 1 )}^{1} + {( d + 1 )}^{2}}$$

### Third Winner

$${N}_{( 3 , 1 )} = \frac{{sg ( d + 1 )}^{0}}{{( d + 1 )}^{0} + {( d + 1 )}^{1} + {( d + 1 )}^{2}}$$

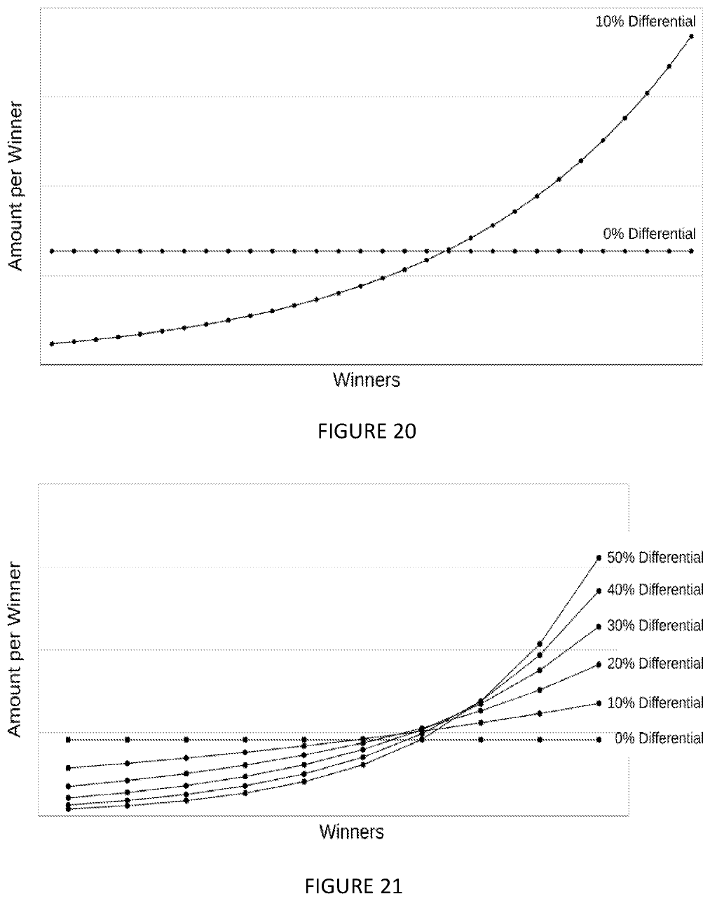

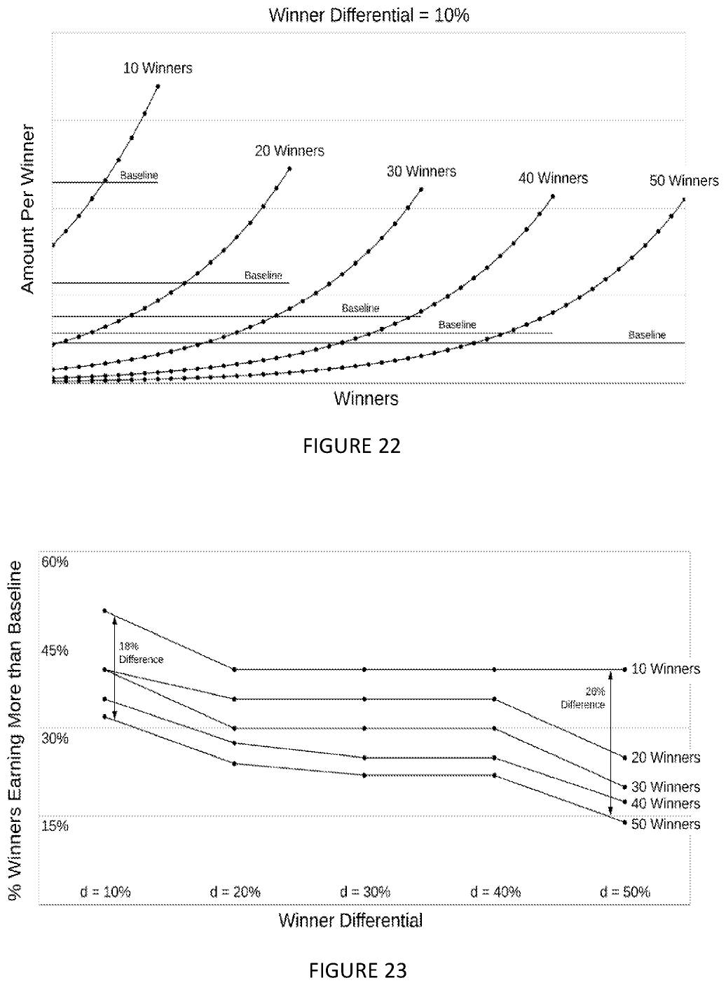

As can be seen from FIG. 20, using a winner differential ensures that subscribers are increasingly rewarded for increased participation in an overall challenge such that higher winners earn significantly more than in a baseline model. Turning to FIG. 21, it can be seen that the choice of winner differential d can drastically affect the distribution of the prize amongst differently ranked winners such that a higher winner differential increases the size of prize for the highest place winner and decreases the size of prize for the lowest placed winner. It can also be seen from FIG. 22 that the greater the number of winners, the greater the impact the winner differential has on the allocation of prizes. For example, for a winner differential d=10%, increasing the number of winners from 10 to 50 only decreases the number of winners earning more than the baseline (equal share of the prize) by 18% whereas for a winner differential d=50%, the number of winners earning more than the baseline decreases by 26%. Despite this decrease, referring to FIG. 23, it can be seen that even with increased numbers of winners, the higher winners can still obtain relatively large prizes above baseline.

In a further alternative, the price may be distributed according to a linear model as determined with the following equation:

$${P}_{R} = \frac{2 {P}_{T} ( N - R + 1 )}{( {N}^{2} + N )}$$

where P_{(R)} is the prize to be awarded to a subscriber for a particular ranking e.g. 1st, P_{(T)} is the total prize to be distributed to winning subscribers, N is the total number of winners, and R is the rank of the specific winner whose prize is being calculated. For example, in a linear distribution model, if the total prize fund is US$15,000, and the total number of winners is 5, the prize is distributed to the top 5 winning subscribers as follows:
P₁=5,000; P₁=4,000; P₁=3,000; P₁=2,000; and P₁=1,000.

The system 1 is configured to enable selection by an establishment of a fixed winner differential e.g. 10%, or selection of an adjustable winner differential which changes according to the total number of winners. If an adjustable winner differential is selected for the prize distribution method of an overall challenge, and the total number of winners is set as a percentage of total participating subscribers, the system 1 is configured to continuously adjust the winner differential as the total number of participating subscribers and, hence, total winners increases or decreases so as to continuously change the prize award for each winning position. In one example, the adjustable winner differential is configured to decrease as the total number of participating subscribers and, hence, total number of winners increases. This has the effect of more evenly distributing the prize fund amongst the winning positions whilst still maintaining a clear separation of prizes between winning positions. Thus, for relatively low numbers of total winners e.g. less than 10, the winner differential may be automatically adjusted to a relatively high percentage, in excess of 100%, and for relatively large numbers of total winners e.g. 100, the winner differential may be automatically adjusted to a relatively low winner differential e.g. 4%.

The system 1 is further configured to allow for selection of different tiers amongst the total number of winners for an overall challenge based on either a winner differential or a linear prize distribution model. The total number of tiers may be set by an establishment as a fixed number e.g. 3, or may be set as a percentage of the total number of winners e.g. 10% of total winners. The tiers may be configured to have different numbers of winners per tier and to have a different level of distribution of winners in each tier so that the gap between winners in one tier is relatively higher than the gap between winners in a different tier.

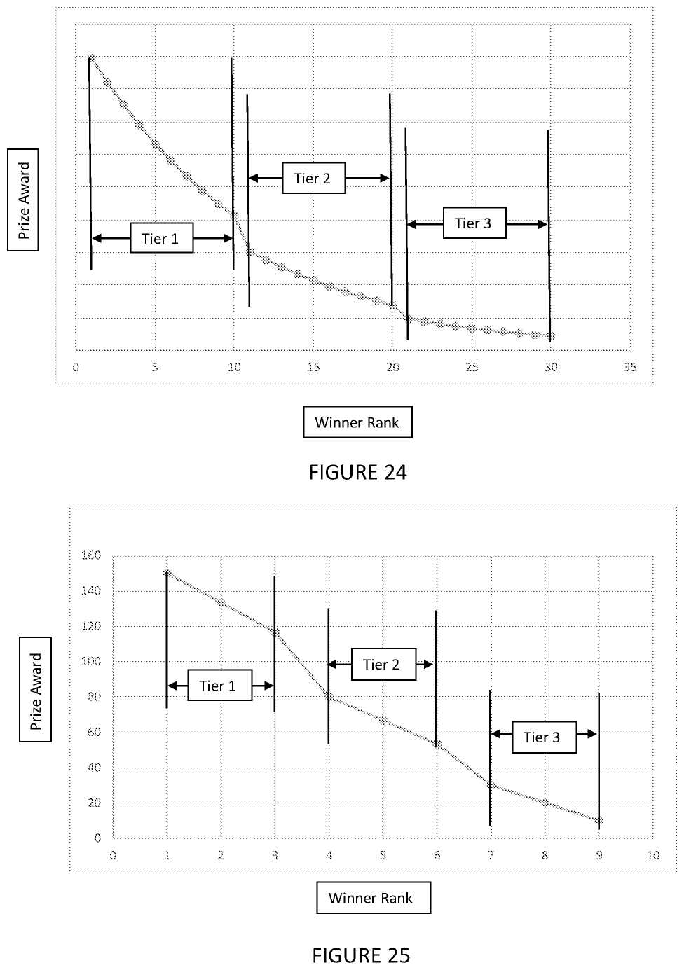

Each tier may be separated from an adjacent tier by a prize difference amount that equates to a marked step from the normal prize difference trend within each tier. For example, with reference to FIG. 24, for an overall challenge based on a winner differential prize distribution model, the overall challenge may be configured to distribute prizes according to a three tier arrangement in which a marked step in prize award is formed between the lowest placed winner of an upper tier and the highest placed winner of the adjacent lower tier. Advantageously, by separating the winners into different tiers, participating subscribers are further incentivised to attempt to spend more and complete sub-challenges in order to achieve a higher ranking and access higher tiers and, hence, higher potential prize awards.

Likewise, with reference to FIG. 25, an overall challenge based on a linear prize distribution model may be configured to have three tiers or ‘leagues’, the total winners distributed equally between the tiers, and wherein each tier has a linear trend for prize distribution amongst winners within the tier, and a marked step up in prize award to the next tier. Thus, the difference in the prize awarded to winners in each tier may be US$100 but the difference between, for example, the highest scoring winner in the second tier and the lowest scoring winner in the top tier may be US$300.

Since the system 1 allows an overall challenge to be configured with a linear or winner differential prize distribution, with or without tiers, with a fixed number of winners or percentage based number of winners, and with an adjustable or fixed winner differential, an establishment may configure an overall challenge to distribute the total prize based on one of twenty four possible distribution models.

The system 1 is also configured to handle distribution of prizes in the event of one or more tied winning positions of an overall challenge and may be allocated according to different models. In one method of allocation, for a linear prize distribution with a fixed number of winners, where there is a tie for a particular position, the system 1 is configured to redistribute the total prize award for the displaced positions equally to the tied winners. For example, where there is a total of five winners and a total prize fund of US$750 distributed according to a linear model such that prizes would ordinarily be paid out in the order P1: $250, P2, $200, P3: $150, P4: $100, P5: $50, and where three participating subscribers are tied for P3 such that P4 and P5 are displaced, the system 1 is configured to redistribute the prize award for P3, P4, and P5 equally to each tied winner such that they all receive $100 i.e. (150+100+50)/3.

Alternatively, the system 1 may be configured to increase the number of total winners by the amount of displaced positions resulting from a tie and to distribute the total prize fund amongst the new total of winners but with tied winners receiving an equal amount. For example, where there is initially specified a total of five winners and there is a total prize fund of US$750 to be distributed at the end of an overall challenge, and where three participating subscribers are tied for P3 such that the P4 and P5 are displaced, the system 1 is configured to increase the total number of winners by the number of displaced positions i.e. two, such that the recalculated total number of winners is seven. The system 1 is configured to calculate the prize award for the new total number of winner positions according to the linear model which, in this example, would be P1: $188, P2: $161, P3: $134, P4: $107, P5: $80, P6: $54, P7: $27 and to redistribute the prize award for the P3, P4, and P5 equally to each tied winner such that the tied winners each receive $107 i.e. (134+107+80)/3. Accordingly, the total prize fund for each winning position would be distributed as P1: $188, P2: $161, P3: $107, P3: $107, P3: $107, P6: $54, P7: $27. The prize fund may be distributed according to a similar calculation in the event more than one different winning position is tied.

Similarly, where an overall challenge is configured to distribute a prize fund according to a winner differential model and there is a tie for one or more winning positions, the system 1 is configured to calculate the normal prize allocation for the total number of winners (whether fixed or recalculated through position displacement) and to equally distribute the total award for the tied positions. For example, where there is specified a total of ten fixed winners and there is a total prize fund of $1,000 at the end of an overall challenge, and the winner differential is set to 50%, the prize fund would normally be allocated as P1: $339, P2: $226, P3: $151, P4: $101, P5: $67, P6: $45, P7: $30, P8: $20, P9: $13, P10: $9. Where there are four ties for P3, the system 1 may redistribute the sum of the awards for P3-P6 equally to the four tied places resulting in P1: $339, P2: $226, P3: $91, P3: $91, P3: $91, P3: $91, P7: $30, P8: $20, P9: $13, P10: $9.

Alternatively, the system may increase the total number of winners by the number of displaced positions and recalculate the prize allocation for the new total number of winners. In the above example, the total number of winners would be increased by four to fourteen such that the new prize allocation would ordinarily be distributed as P1: $334, P2: $223, P3: $149, P4: $99, P5: $66, P6: $44, P7: $29, P8: $20, P9: $13, P10: $9, P11: $6, P12: $4, P13: $3, P14: $2. As above, where there are four ties for P3, the system 1 may redistribute the sum of the awards for P3-P6 equally to the four tied places resulting in P1: $334, P2: $223, P3: $89.5, P4: $89.5, P5: $89.5, P6: $89.5, P7: $29, P8: $20, P9: $13, P10: $9, P11: $6, P12: $4, P13: $3, P14: $2.

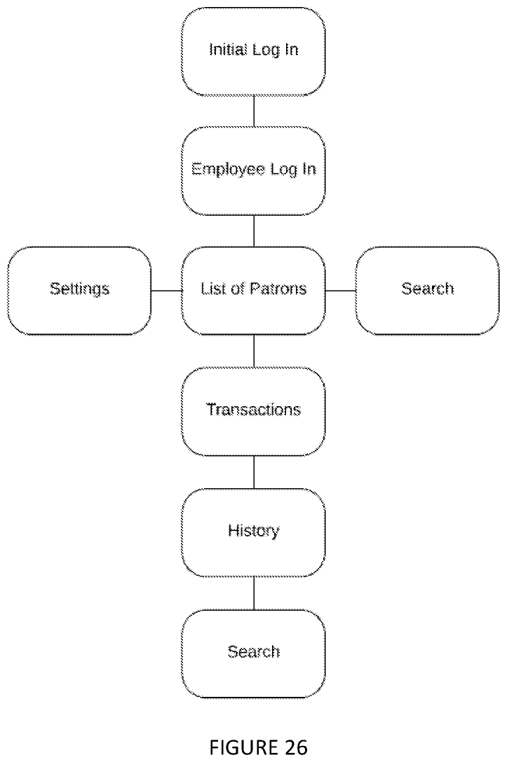

Pages of an exemplary user interface of a verification module displayed on a verification device 9 such as a tablet computer or point of sale device are depicted schematically in FIG. 26. The verification module user interface comprises a login page to enable access to a list of patrons determined by the system 1 to be at the premises of the establishment. The patron list includes pictures of each patron or subscriber and their name contained within a tile which forms a touch actuated button. A search facility is also provided permitting establishments to search for subscribers of their program with name, player ID, or a transaction code. Selecting a particular subscriber opens a subscriber profile page which indicates the subscriber's available store credit and which enables the establishment to input details of a transaction to be assigned to the selected subscriber. The interface enables establishments to enter a total for the sale of goods, enter a sale with a redemption of store credit, or to correct the amount of credit assigned to a subscriber. Upon submission of the sale details or credit correction, a verification signal is sent to the server to update the subscriber's account with additional virtual points and/or cashback or to amend the amount of credit stored within the subscriber's account.

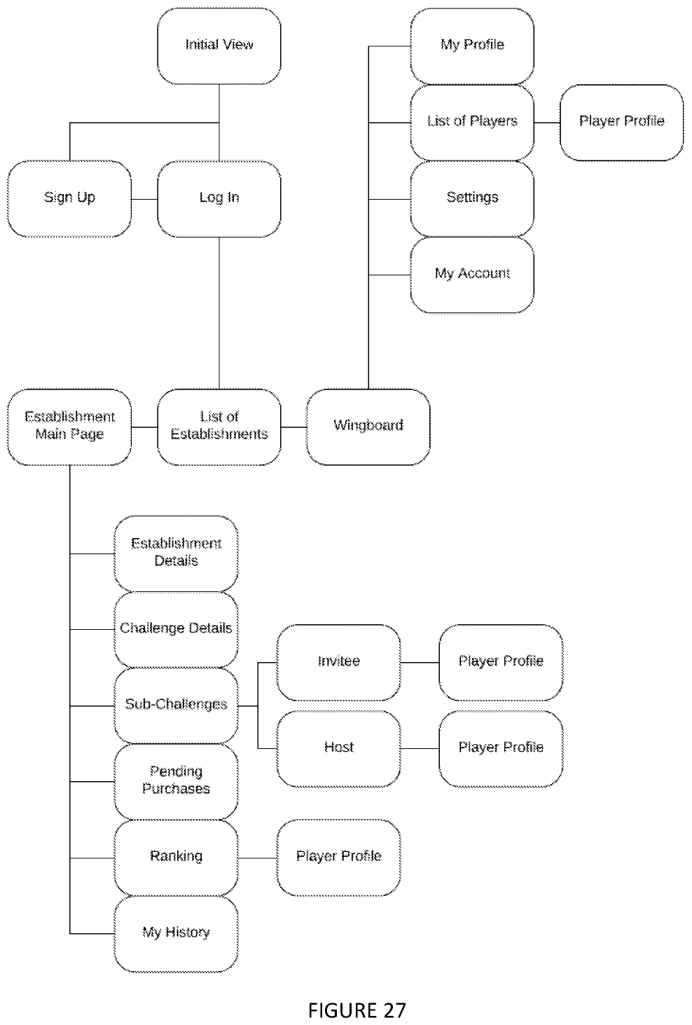

Pages of an exemplary user interface of a loyalty program access module that can be displayed on one or more communication devices 11 such as a smartphone are depicted schematically in FIG. 27. The user interface includes account sign up and login pages for subscribers to access and configure their account and sign up to establishment programs. Upon login or sign up, the access module is configured to open with a page that lists establishment programs and which provides access to further pages within the program via touchscreen buttons associated with each establishment. Selecting one particular establishment opens an establishment view page which provides basic details about the establishment including a photograph of the venue, details of the current prize fund available for a particular establishment's overall challenge (if running), a subscriber's current rank (if any) in the overall prize, the number of sub-challenge or ‘boosters’ currently running as part of the overall challenge, and details of the cashback and credit earned to date with the establishment.

From the establishment view, a subscriber can access six different establishment related sections including a history section, an establishment details section, an overall challenge details section, a ranking page, a pending purchases section and a sub-challenge section. When a check-in or invitation sub-challenge is in play, the subscriber will receive check-in notifications to alert the subscriber to commencement of such a sub-challenge.

Additional pages within the loyalty program access module may be accessed via a ‘wingboard’ style button interface which may be accessed from the home page by gesture control such as swiping the screen from left to right. The wingboard lists a plurality of touch buttons which, in a preferred embodiment, comprise a ‘my profile’ button, a ‘list of players’ button, ‘settings’ button, and ‘my account’ button.

The ‘my profile’ button leads to a profile page which provides an overview of the total cashback and prizes won and the number of establishment programs to which the subscriber is subscribed. The ‘list of players’ button leads to a player listing page which lists other subscribers of the system 1 and enables a subscriber to take certain actions in relation to each other subscriber such as save the player to contacts, block the player, or take no action. One or more players can be invited from the player listing page to take part in challenges and sub-challenges so that both the inviter or host and the invitee can earn virtual points. The settings button leads to a settings page which permits settings for the loyalty program access module to be adjusted as desired and which also enables the subscriber to take various account related actions such as change password, change user name, and delete account.

The pending purchase page for an establishment may be accessed from the establishment view so that a subscriber can determine how many virtual points will be redeemed upon completion of an order. A ‘pay with store credit’ button is provided to enable the subscriber to easily and conveniently settle a pending transaction with an establishment with any earned store credit for that establishment.

The user interface enables a subscriber to subscribe to a number of different establishment loyalty programs, participate in challenges and sub-challenges, monitor current ranking and available prizes, and even spend earned store credit. Advantageously, the system 1 provides a convenient method for a number of different establishments to engage with existing and new customers and to generate increased revenues.

It is envisaged that the system 1 could be scaled up to enable establishments to form groups in which virtual points and credit are shared. Subscribers of establishments within the created group may then compete for a collective prize fund which may be far greater than a single establishment's prize fund.

It is further envisaged that the system 1 could be implemented to encourage establishments, as well as patrons/subscribers, to compete against one another. For example, a challenge may be configured with a prize fund for the highest earning establishment over a given period of time. Furthermore, it is envisaged that the system 1 could be configured to enable establishments to sell opportunities to third parties to promote themselves to establishments' subscriber base. For example, in return for a fee, an establishment may create a sub-challenge to promote a brand's goods to an establishment's subscribers.

It is envisaged the system 1 need not be limited to traditional bricks and mortar establishments and could also be implemented in an e-commerce environment. For example, an e-commerce platform may register an account with the system 1 and create an overall challenge and one or more sub-challenges by transmitting desired challenge or sub-challenge parameters to the program server 3 for processing and storage by the universal loyalty program module. The universal loyalty program module and/or the establishment may then transmit details of the challenge or sub-challenge via the internet 5 to the communication devices 11 of subscribers of the e-commerce platforms loyalty program for their participation. Additionally or alternatively, the e-commerce website may include an indication that a particular product on its website is the subject of a purchase sub-challenge with a corresponding reward. Participating subscribers that complete sub-challenges may then be awarded virtual points by the universal loyalty program module upon receipt of a verification signal associated with a subscriber indicating completion of a sub-challenge.

In an e-commerce environment without a physical establishment, the verification device 9 may be a server with a verification module that generates a verification signal associated with the individual subscriber for transmission to the program server 3 for further processing and updating of the subscriber's stored record. For example, a purchase sub-challenge may be created that involves purchasing a particular product on an e-commerce website. The e-commerce website server may generate a purchase event including details of the purchase and information necessary for the system 1 to identify the subscriber and transmit data of the purchase event to the program server 3. Upon receipt of this verification signal from the e-commerce website server, the universal loyalty program module uses the identification information to identify the subscriber on the system 1 and uses the purchase information to determine that a specified product of the purchase sub-challenge has been purchased by the subscriber and to update the subscriber's stored account with the reward associated with the purchase sub-challenge e.g. 50 virtual points.

It is envisaged that the system 1 could be monetized by the platform provider in any number of ranges including on a subscription basis (including additional payment for additional features), usage basis, or as a percentage of the total prize offering (for overall sales/directly added sub-challenges) or any one or more hybrids of these.

It is also envisaged the system 1 could be implemented in hospitality or service industries such as airlines or cruise liners. For example, the system 1 could be used to create loyalty programs with overall challenges and sub-challenges that incentivise subscribers to preferentially fly or travel with the airline or cruise liner, undertake certain actions whilst on board the aircraft or cruise liner, purchase particular items, and promote the airline or cruise liner to contacts of the subscribers via social media.

The system 1 need not be limited to retail, hospitality, or service industries, and could be used in any environment where it would be beneficial to incentivise individuals or teams to achieve specified goals.

For example, an educational establishment may use the system 1 to create an overall challenge having an overall prize or overall reward for the highest performing participating teams or individuals. The establishment then may create one or more sub-challenges of the overall challenge to encourage participating teams or individuals to complete tasks or work to obtain the rewards necessary to qualify as one of the highest performing participants of the overall challenge in order to be we awarded an overall prize or overall reward at the completion of an overall challenge.

The prize or reward may be known at the outset of the challenge/sub-challenge, revealed (and updated if appropriate) during the progress of the challenge/sub-challenge, or revealed at the end of the challenge to maximize the engagement of participants. Where prizes or rewards are modified during the challenge/sub-challenge this information may or may not be disclosed by specifying settings on the platform. It would be appreciated that the prize or reward could be virtual points, physical prizes/items, store credits, access to exclusive opportunities or combination of these, provided by the institution, platform or third party without departing from the scope of the present disclosure.

The overall challenge may be to achieve the highest number of virtual points or tokens for completing one or more sub-challenges. The sub-challenges may involve writing an article or a set number of articles, completing an assignment by a certain date, publishing a minimum number of research papers within a certain time period, or any other goal relevant to an educational establishment. It will be appreciated that such an overall challenge with sub-challenges could be used not only to incentivise students to complete tasks but also to incentivise academic staff to achieve certain academic goals that are beneficial to the educational establishment. Optionally, the points attained by participants in the challenge may be displayed to all participants throughout the duration of the challenge to promote competition, for example ranking participants on a web page “leader board” with participants fully disclosed, anonymized in part, or anonymized in full, depending on the decision by the institution and corresponding updates to settings of the underlying platform.

Likewise, the system 1 could be used to create an overall challenge and sub-challenges that incentivise employees in the workplace to achieve work related goals within specified time periods in a variation of the traditional fixed commission per sale to top sales staff/sliding scale arrangements.

For example, a company may create an overall challenge with a financial reward or bonus for the highest performing participating individuals or teams. Sub-challenges of the overall challenge may be created with associated virtual points that may be awarded in return for completion of one or more sub-challenges, or completion of which may have associated credit or cash back.

For example, at a car dealership, sales staff could have a one month challenge where a percentage of every car sold goes towards the overall collective prize to be distributed amongst the top sales staff (This is similar to a customer challenge where a percentage of a sale goes to build a collective prize). Points could be awarded to the sales staff for the sale of each vehicle, together with sub-challenges which award points or store credit. Optionally, a percentage of the sale may go immediately to the staff who made the sale, in the cash-back arrangement or credit sub challenge. Sub-challenges may also include completing a work assignment by a certain date, writing a minimum number of articles for publication, attending networking events, giving seminars, or any other task or goal that may be relevant in a work environment and that may be beneficial to the company. Teams may be selected so as to enable stronger performers to mentor weaker performers in achieving good results in the sub-challenges presented. At the completion of the overall challenge, the individuals or teams with the most virtual points may then be awarded the financial reward or bonus. It would be appreciated that the challenges could be customized according to different work environments without departing from the scope of the present disclosure.

Again, the points attained by participants in the challenge may be displayed to all participants throughout the duration of the challenge to promote competition, for example rankings on a web page “leader board” with participants fully disclosed, anonymized in part, or anonymized in full, depending on the decision by the workplace and corresponding settings made to the underlying platform.

Similarly, the prize or reward may be known at the outset of the sub-challenge, revealed (and updated if appropriate) during the progress of the sub-challenge, or revealed at the end of the challenge to maximize the engagement of participants. Where prizes or rewards are modified during the challenge this information may or may not be disclosed by modifying settings of the underlying platform. It would be appreciated that the prize or reward could be virtual points, physical prizes/items, store credits, access to exclusive opportunities or any combination of these, the prizes being provided by the institution, platform or third party without departing from the scope of the present disclosure.

The system 1 could also be used, for example, to incentivise individuals to achieve personal fitness goals within specified time limits. A fitness establishment may create an overall challenge to be won by participants for completing various sub-challenges such as posting photographs of the fitness establishment on social media, thereby promoting the establishment and simultaneously encouraging participants to attend the establishment, inviting friends to attend fitness classes, attending the establishment a minimum number of times in a week, or any other goal or task relevant to a fitness establishment that may help promote the establishment, increase the use of its facilities, and help an individual achieve a personal fitness goal.

It would be appreciated that the same establishment (or business or educational institution) could implement the foregoing systems of the present disclosure in parallel or in sequence—for example customers could be incentivized by certain sub-challenges at the same time that staff of the establishment are incentivized by different sub-challenges. Hence the same system can provide different foci for incentivizing activities.

The above embodiments are described by way of example only. Many variations are possible without departing from the scope of the invention as defined in the appended claims.

1. A computer implemented method of updating a stored record associated with a subscriber of a program comprising:
receiving, by one or more computing devices, one or more parameters of a sub-challenge of an overall challenge sent from an input device, one or more computing devices comprising a memory, a processor, and a network interface;
the one or more parameters including a reward associated with the sub-challenge;
storing the one or more parameters in memory of one or more computing devices;
transmitting, via a network interface, details of the sub-challenge to a communication device accessible by the subscriber of the program;
receiving, by one or more computing devices, a verification signal from a verification device indicating completion of the sub-challenge by the subscriber; and
updating the record associated with the subscriber to include the reward.

2. A method as claimed in claim 1, wherein the verification signal comprises data facilitating identification of the subscriber and data facilitating determination that criteria for completion of the sub-challenge have been met.

3. A method as claimed in claim 1, further comprising determining, by one or more computing devices, completion of a sub-challenge based upon the verification signal.

4. A method as claimed in claim 1, further comprising selecting a subscriber from a list of subscribers displayed on the verification device or inputting details relating to a subscriber into the verification device, and including in the verification signal data identifying the selected subscriber.

5. A method as claimed in claim 1, wherein the sub-challenge includes one or more of purchasing goods or services, visiting a physical location, inviting others to visit a physical location, inviting an individual to complete a task, purchasing specific goods or services, purchasing a minimum value or minimum number of goods or services, viewing a video, promoting an establishment or third party through social media channels, providing feedback to an establishment, completing a knowledge based game, or completing a task.

6. A method as claimed in claim 1, wherein the one or more parameters further include one or more of a time constraint, quantity constraint, reward multiplier, set number of points, start time, end time, start date, restriction on the number of times a sub-challenge may be completed by the subscriber, or restriction on the total number of rewards that may be awarded to the subscriber for a given sub-challenge.

7. A method as claimed in claim 1, wherein at least one parameter is selected from one or more pre-configured parameter types.

8. A method as claimed in claim 1, wherein the reward comprises a number of virtual points, a prize, cashback, credit, access to one or more exclusive opportunities, or a combination thereof.

9. A method as claimed in claim 8, wherein prize information is displayed at any one or more of the beginning of the sub-challenge/challenge, during the sub-challenge/challenge and after the completion of the challenge/sub-challenge.

10. A method as claimed in 9, wherein prize information is displayed during the challenge and dynamically updated during the challenge.

11. A method as claimed claim 1, wherein communication between a communication device and one or more computing devices takes place over a network.

12. A method as claimed in claim 1, further comprising the step of activating an alert on the communication device accessible by the subscriber of the program to cause details of an overall challenge or sub-challenge to display on a display of the communication device accessible by the subscriber of the program to encourage the subscriber of the program to participate in the overall challenge or sub-challenge.

13. A method as claimed in claim 1, further comprising the step of comparing the stored record of a participating subscriber of an overall challenge with respective records of one or more other participating subscribers, ranking each participating subscriber in order based on the respective stored records and transmitting the ranking to one or more communication devices for displaying the ranking on a display of one or more communication devices.

14. A method as claimed in claim 1, wherein sending of a verification signal verifying completion or part completion of a sub-challenge is activated by a software application.

15. A method as claimed in claim 14, wherein activation by the software application is triggered by receipt of data by the verification device confirming completion or part completion of a sub-challenge by the subscriber.

16. A method as claimed in claim 1, further comprising the steps of monitoring the location of one or more subscribers.

17. A method as claimed in claim 16, further comprising the step of displaying details of one or more subscribers on the verification device when one or more subscribers is determined to be at, or within a specified distance of, a specified location.

18. A method as claimed in claim 16, further comprising the step of updating the record associated with a subscriber to include a reward when the subscriber is determined to be at, or within a specified distance of, a specified location.

19. A computer implemented method of verifying completion of a sub-challenge of an overall challenge by a subscriber of a program, said sub-challenge being associated with a reward for completion of the sub-challenge, the method comprising:
receiving, by one or more computing devices, information relating to the completion of the sub-challenge, said information including data for identification of the subscriber;
sending, by one or more computing devices, an identification request to a verification device, said identification request including said data for identification of the subscriber;
selecting, based on said data for identification of the subscriber, a subscriber from a list of subscribers displayed on the verification device or inputting details associated with a subscriber into the verification device; and
sending, by the verification device, a verification signal to one or more computing devices, said verification signal including details associated with the selected subscriber; and updating, by one or more computing devices, a stored record associated with the subscriber to include the reward associated with the sub-challenge.

20. A method as claimed in claim 19, further comprising determining, by one or more computing devices, completion of a sub-challenge based on said information relating to the completion of the sub-challenge and/or said verification signal.

21. A method as claimed in claim 19, wherein the information relating to the completion of the sub-challenge comprises data relating to the order of goods and/or services and said data for identification of the subscriber comprises a unique identifier associated with the order of goods and/or services.

22. A method as claimed in claim 21, further comprising sending to one or more computing devices the information relating to the completion of the sub-challenge.

23. A computer based system for updating a stored record associated with a subscriber of a program comprising:
one or more computing devices comprising a memory, a processor, and a network interface, one or more computing devices operable to receive one or more parameters of a sub-challenge of an overall challenge sent from an input device and store the one or more parameters in memory, the one or more parameters including a reward associated with the sub-challenge;
one or more computing devices operable, via a network interface, to transmit details of the sub-challenge including at least one parameter of the one or more parameters to a communication device accessible by the subscriber of the program;
wherein one or more computing devices is configured to update the record associated with the subscriber to include the reward upon receipt of a verification signal indicating completion or part completion of a sub-challenge sent from a verification device.

24. A computer based system as claimed in claim 23, further comprising one or more communication devices accessible by one or more subscribers of a program.

25. A computer based system as claimed in claim 23, further comprising a verification device for transmitting the verification signal indicating completion of a sub-challenge to the server.

26. A computer based system as claimed in claim 23, wherein the verification device, input device, and/or communication device are the same device.
